(19) United States
(12) Patent Application Publication
(10) Pub. No.: US 2009/0142094 A1
(43) Pub. Date: Jun. 4, 2009

(54) TONER, DEVELOPER, PROCESS CARTRIDGE, AND IMAGE FORMING APPARATUS

(76) Inventors: Toyoshi Sawada, Hiratsuka-shi (JP); Tomomi Suzuki, Numazu-shi (JP); Tsuneyasu Nagatomo, Numazu-shi (JP); Takuya Seshita, Hiratsuka-shi (JP); Satoshi Kojima, Numazu-shi (JP); Junichi Awamura, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/271,406

(22) Filed: Nov. 14, 2008

(30) Foreign Application Priority Data
Nov. 29, 2007 (JP) 2007-308505
Nov. 30, 2007 (JP) 2007-310512
Nov. 30, 2007 (JP) 2007-310513

(51) Int. Cl. G03G 21/18; G03G 9/08; G03G 15/16

(52) U.S. Cl. 399/111; 430/111.4; 430/108.8; 399/302

(57) ABSTRACT

A toner including a binder resin and a colorant which produces a torque of from 1.4 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm. The bulk of the toner is formed by consolidating 30 g of the toner in a cylindrical container having an internal diameter of 60 mm for 60 seconds with a consolidation load of 585 g.

### BACKGROUND OF THE INVENTION

1. Field of the Invention

The present invention relates to a toner for use in electrophotography. In addition, the present invention also relates to a developer, a process cartridge, and an image forming apparatus using the toner.

2. Discussion of the Background

In accordance with increasing demands for high image quality and energy conservation, development of toner and developer has been accelerated recently. To respond to the demand for high image quality, toner is required to be small-sized and uniform-sized, as such a toner can reliably reproduce microdots because each of the toner particles behaves uniformly.

Polymerization methods have received attention recently as a manufacturing method of such small-sized and uniform-sized toner. Specific examples of polymerization methods include a suspension polymerization method, an emulsion aggregation method, a dissolution suspension method, and the like.

To respond to the demand for energy conservation, toner is required to be fixable at low temperatures (this property is hereinafter referred to as low-temperature fixability). Therefore, polyester resins that have good low-temperature fixability as well as thermostable preservability are preferable as a binder resin instead of conventionally-used styrene acrylic resins, and research continues on ways to further improve low-temperature fixability.

One proposed approach involves reducing the glass transition temperature of the binder resin. However, if the glass transition temperature is reduced too much, thermostable preservability of the resultant toner may deteriorate. Another proposed approach involves reducing the softening temperature of the binder resin. However, if the softening temperature of the binder resin is reduced too much, the resultant toner may cause hot offset at lower temperatures. The “hot offset” here refers to an undesirable phenomenon in which part of a fused toner image is adhered to the surface of a heat member, and re-transferred onto an undesired portion of a recording medium. Accordingly, a toner having low-temperature fixability and resistance to hot offset (hereinafter “hot offset resistance”) is not yet provided only by controlling thermal properties of the polyester binder resins.

At the same time, a developer including such a toner and a carrier is typically agitated in a copier for an extended period of time. Therefore, if a release agent and the polyester resin having a low-melting point are included in the toner, these materials tend to adhere to the carrier, degrading charging ability of the carrier. As a result, charge of the developer may decrease.

Moreover, if concavities and convexities are formed on the surfaces of toner particles, silica particles that are typically externally mixed with the toner particles as fluidizers may adhere weakly to the convexities and migrate to the concavities. As a result, the toner particles tend to adhere to an image bearing member (hereinafter “photoreceptor”) and/or a fixing roller.

Among the polymerization methods, a dissolution suspension method is advantageous because polyester resins can be used therefor. However, the dissolution suspension method involves a process in which a binder resin and a colorant are dissolved or dispersed in a solvent optionally together with a high-molecular-weight component for the purpose of widening fixable temperature range of the resultant toner, possibly increasing viscosity of the solvent and causing various problems in the manufacturing process as a consequence.

Thus, for example, Unexamined Japanese Patent Application Publication No. (hereinafter “JP-A”) 09-15903 discloses a manufacturing method of toner including processes of mixing a binder resin with a colorant in a solvent immiscible with water; dispersing the resultant composition in an aqueous medium in the presence of a dispersion stabilizer; removing the solvent from the resultant suspension by application of heat or reduction of pressure; forming particles having concavities and convexities on the surfaces thereof; and sphering or deforming the particles by application of heat. The resultant toner particles have an irregular shape, and therefore charge stability thereof is poor. Moreover, the molecular weight of the binder resin is not designed to have durability and fixability.

Accordingly, given the importance of achieving and maintaining desired toner fluidity, various approaches have been developed to measure such fluidity. Thus, for example, JP-As 2004-177371, 2004-177850, and 2006-78257 each disclose a method and a device for evaluating fluidity of toner for use in electrophotography. Specifically, the fluidity of toner is evaluated by measuring torque or load produced when a cone rotor intrudes into a bulk of the toner while rotating.

In JP-A 2004-177371, the ratio of the intruding speed (mm/min) to the rotation speed (rpm) of the cone rotor is set to from 2/1 to 20/1 so that fluidity is reliably measured.

In JP-A 2004-177850, the cone rotor previously starts rotating before intruding into the bulk of the toner so that fluidity is more reliably measured.

In JP-A 2006-78257, measurement conditions are further improved so that fluidity is more accurately measured without measurement variation.

Even when the fluidity of the toner is measured accurately, however, it must be kept within certain limits and balanced against competing priorities of cleanability, developability, and transferability, particularly when used in an image forming apparatus employing an intermediate transfer method, as is described in detail below.

In the conventional intermediate transfer method, toner images formed on an image bearing member are sequentially transferred onto an intermediate transfer member, and the toner images thus transferred onto the intermediate transfer member are further transferred onto a recording medium at once. The image bearing member is configured to bear a toner image corresponding to image information, and a photoreceptor may be used as the image bearing member, for example. As the intermediate transfer member, an endless intermediate transfer belt stretched taut by multiple rollers may be used, for example. A unit configured to transfer a toner image from a photoreceptor onto an intermediate transfer member is called a primary transfer unit. The primary transfer unit is required to reliably transfer the toner image from the photoreceptor onto the intermediate transfer member using an electric field formed between the photoreceptor and the intermediate transfer member. A unit configured to transfer the toner image from the intermediate transfer member onto a recording medium is called a secondary transfer unit. The secondary transfer unit is required to reliably transfer the toner image from the intermediate transfer member onto the recording medium using an electric field formed between the intermediate transfer belt and the recording medium.

Both the primary and secondary transfer units are required to reliably transfer a toner image with high transfer efficiency. When the transfer efficiency deteriorates because the friction coefficient is too large, a central part of an image, particularly a line image or a text image, tends not to be transferred onto a recording medium, producing defects in the resultant image.

To prevent the occurrence of such a phenomenon, one proposed approach involves applying a lubricant to a photoreceptor to reduce the friction coefficient so that the adherence of toner to the photoreceptor decreases, as disclosed in JP-A 08-211755. Alternatively, another proposed approach involves optimizing a relation between the friction coefficients of a photoreceptor and an intermediate transfer belt, as disclosed in JP-As 06-332324 and 2000-19858.

In addition, the friction coefficient has a close relation not only to the transfer efficiency but also to the degree of deformation of a cleaning blade configured to remove residual toner particles that are not transferred. To prevent the deformation of a cleaning blade, one proposed approach involves applying a lubricant to a cleaning target, as disclosed in JP-As 57-17973, 07-271142, and 2001-75449. Conditions for applying a lubricant and the resultant friction coefficient of the cleaning target need to be optimized so that both the production of images with defects and deformation of a cleaning blade are prevented.

### SUMMARY OF THE INVENTION

Accordingly, illustrative embodiments of the present invention provides a toner and a developer having a good combination of low-temperature fixability, hot offset resistance, cleanability, and chargeability for an extended period of time, and a process cartridge and an image forming apparatus capable of producing high quality images with high transfer efficiency.

One illustrative embodiment provides a toner including a binder resin and a colorant which produces a torque of from 1.4 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm. The bulk of the toner is formed by consolidating 30 g of the toner in a cylindrical container having an internal diameter of 60 mm for 60 seconds with a consolidation load of 585 g.

Another illustrative embodiment provides a toner including a binder resin and a colorant which produces (1) a torque of from 1.4 to 2.0 mNm and (2) a torque of from 1.7 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm. The bulk of the toner is formed by consolidating 30 g of the toner in a cylindrical container having an internal diameter of 60 mm for 60 seconds with a consolidation load of (1) 585 g and (2) 1599 g, respectively.

Yet another illustrative embodiment provides a developer, a process cartridge, and an image forming apparatus including the toners described above.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of a device for measuring torque;

FIG. 2 is a schematic view illustrating another embodiment of a device for measuring torque equipped with a unit for consolidating a toner;

FIGS. 3A and 3B are schematic front and cross-sectional bottom views, respectively, illustrating an embodiment of a cone rotor;

FIGS. 4 and 5 are schematic views for explaining the shape factors SF-1 and SF-2, respectively;

FIG. 6 is a schematic view illustrating an embodiment of a process cartridge according to illustrative embodiments of the present invention;

FIG. 7 is a schematic view illustrating an embodiment of a full-color image forming apparatus according to illustrative embodiments of the present invention;

FIG. 8 is a schematic view illustrating an embodiment of an image forming unit included in the image forming apparatus illustrated in FIG. 7;

FIGS. 9 and 10 are schematic views illustrating embodiments of a lubricant applicator included in the image forming unit illustrated in FIG. 8; and

FIG. 11 is a diagram showing a band-like image used for evaluation of the toners of the present invention.

### DETAILED DESCRIPTION OF THE INVENTION

A first illustrative embodiment of the present invention provides a toner which produces a torque of from 1.4 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm, wherein the bulk of the toner is formed by consolidating 30 g of the toner in a cylindrical container having an internal diameter of 60 mm for 60 seconds with a consolidation load of 585 g.

A second illustrative embodiment of the present invention provides a toner which produces (1) a torque of from 1.4 to 2.0 mNm and (2) a torque of from 1.7 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm, wherein the bulk of the toner is formed by consolidating 30 g of the toner in a cylindrical container having an internal diameter of 60 mm for 60 seconds with a consolidation load of (1) 585 g and (2) 1599 g, respectively.

The inventors of the present invention found that the fluidity of toner can be precisely evaluated by the torque measured as above (this measuring method is hereinafter referred to as a torque evaluation method), and the torque thus measured has a close relation to the cleanability of the toner. When the torque measured by the torque evaluation method is large, it means that interactions between the consolidated toner particles are large. Therefore, if such toner particles remain on a photoreceptor without being transferred and banked off by a cleaning blade, the toner particles tend to aggregate and form a toner particle layer on the cleaning blade. As a result, remaining toner particles may be banked off not only by the cleaning blade but also by the toner particle layer, providing good cleanability.

According to the first illustrative embodiment, when the torque measured by the torque evaluation method is less than 1.4 mNm, it means that the cleanability of the toner is poor. When the torque measured by the torque evaluation method is greater than 2.0 mNm, the toner has too low a fluidity, possibly causing clogging in piping. Accordingly, the toner according to the first illustrative embodiment is designed to produce a torque of from 1.4 to 2.0 mNm, measured by the torque evaluation method.

Generally, the torque increases as the degree of deformation of a toner increases. Therefore, the torque can be set to within a range of from 1.4 to 2.0 mNm by appropriately controlling the shape of the toner particles.

The toner according to the second illustrative embodiment satisfies both the following two conditions (1) that shows cleanability at high linear speeds and (2) that shows cleanability at low linear speeds, in order to provide reliable cleanability regardless of the linear speed of the photoreceptor.

(1) When a bulk of a toner is formed by consolidating 30 g of the toner in a cylindrical container having an internal diameter of 60 mm for 60 seconds with a consolidation load of 585 g, and a cone rotor having a vertical angle of 60° and grooves on a surface thereof then intrudes into the bulk of the toner at an intrusion speed of 5 mm/min for a depth of 20 mm while rotating at a rotation speed of 1 rpm, the toner produces a torque of from 1.4 to 2.0 mNm. When the torque is less than 1.4 mNm, the cleanability of the toner is poor. When the torque is greater than 2.0 mNm, the toner has too low a fluidity, possibly causing clogging in piping.
(2) When a bulk of a toner is formed by consolidating 30 g of the toner in a cylindrical container having an internal diameter of 60 mm for 60 seconds with a consolidation load of 1599 g, and a cone rotor having a vertical angle of 60° and grooves on a surface thereof then intrudes into the bulk of the toner at an intrusion speed of 5 mm/min for a depth of 20 mm while rotating at a rotation speed of 1 rpm, the toner produces a torque of from 1.7 to 2.0 mNm. When the torque is less than 1.7 mNm, the cleanability of the toner is poor. When the torque is greater than 2.0 mNm, the toner has too low a fluidity, possibly causing clogging in piping.

In a process in which a toner is charged and developed, the smoother the surface of the toner and the smaller the torque measured by the torque evaluation method, the smaller an area of contact of the toner with a carrier (in a two-component developing method) or a developing sleeve (in a one-component developing method). Since the toner point-contacts a carrier or a developing sleeve, the toner easily rolls on the surface of the carrier or the developing sleeve. As a result, a wax and/or a binder resin having a low melting point that are dispersed in the toner tend to adhere to the carrier or the developing sleeve, thereby degrading the charging ability of the carrier or the ability for drawing up the toner of the cleaning blade, respectively.

In addition, the smaller the toque measured by the torque evaluation method, the smaller the interactions between the toner particles. When the torque measured by the torque evaluation method is too small, in particular less than 1.4 mNm, the toner barely releases from the surface of the carrier even when being agitated. As a result, such a toner is replaced little if at all with a fresh supply of toner, degrading charging ability of the carrier.

On the other hand, when the toner has a rough surface, i.e., the torque measured by the torque evaluation method is too large, in particular greater than 2.0 mNm, the toner particles tend to aggregate due to the interactions therebetween. Such a toner is barely dispersed in a developer, resulting in uneven toner concentration in a developing device.

Accordingly, the toner of the present invention produces a torque of from 1.4 to 2.0 mNm as measured by the torque evaluation method particularly when a bulk of the toner is formed by consolidating 30 g of the toner in a cylindrical container having an internal diameter of 60 mm for 60 seconds with a consolidation load of 585 g.

It should be noted that as the torque of a toner measured by the torque evaluation method increases, the toner more easily produces an image with defects. Therefore, surface properties, in particular the surface friction coefficient, of a photoreceptor and an intermediate transfer member should be also optimized so that cleanability, developability, and transferability are all satisfactory.

The torque evaluation method is disclosed in JP-A 2006-78257, the disclosures thereof being incorporated herein by reference. In the torque evaluation method, as described above, a cone rotor is intruded into or drawn up from a bulk of a toner while rotating, while a torque applied to the cone rotor and a load applied to a container containing a toner is measured. The fluidity of the toner can be evaluated by the torque and load thus measured.

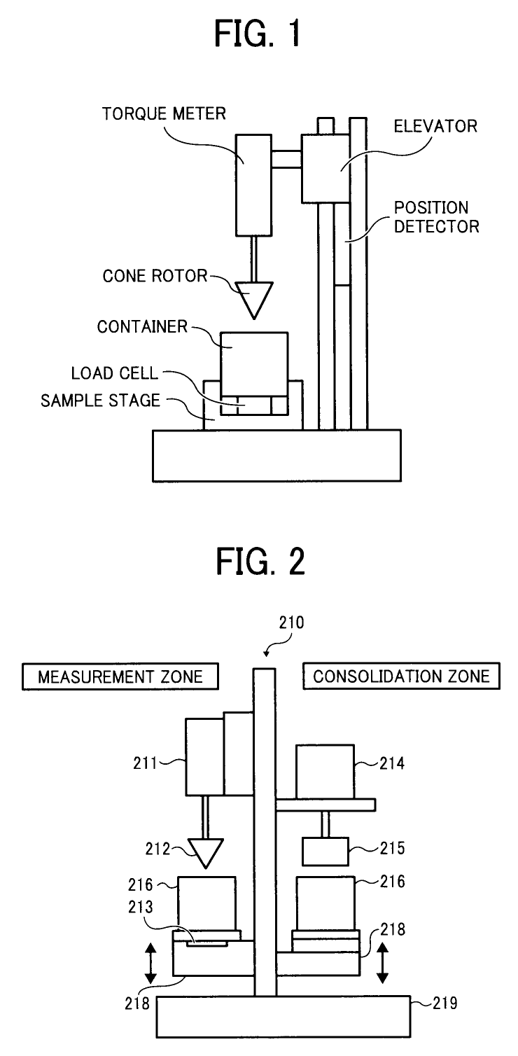

FIG. 1 is a schematic view illustrating an embodiment of a device for measuring torque. A cone rotor is set to an end of a shaft of a torque meter. The torque meter can be lifted or lowered by an elevator. A container containing a toner is set on the center of a sample stage so that the cone rotor intrudes into the center of the container while rotating when the cone rotor is lowered. The torque meter detects a torque applied to the cone rotor, and a load cell provided below the container detects a load applied to the container. A position detector detects an intrusion distance of the cone rotor.

It is to be noted that embodiments of the device for measuring torque are not limited to the above-described configuration. For example, another embodiment of the device for measuring torque may have a configuration such that a container containing a toner can be lifted or lowered by an elevator.

FIG. 2 is a schematic view illustrating another embodiment of a device for measuring torque equipped with a unit for consolidating a toner. An evaluation device 210 includes a consolidation zone and a measurement zone. The consolidation zone includes a container 216 configured to contain a toner, an elevating stage 218 configured to lift or lower the container 216, a piston 215 configured to consolidate the toner, and a weight 214 configured to apply a load to the piston 215.

The container 216 containing the toner is lifted so that the toner contacts the piston 215. Subsequently, the container 216 is further lifted so that all the weight of the weight 214 is applied to the piston 215. Namely, the weight 214 is supported only by the piston 215 while separated from a pedestal 219. After being left for a predetermined time, the container 216 is detached from the piston 215 by lowering the elevating stage 218.

The piston 215 is made of a material having a smooth surface to reliably consolidate the toner. Processible, hard, and non-transmutable materials are preferable for the piston 215. In addition, in order to prevent an electric adherence of the toner to the piston 215, conductive materials are preferably used therefor. Specific preferred examples of suitable materials include, but are not limited to, SUS, Al, Cu, Au, Ag, and brass.

In the present embodiment, the container 216 is a cylindrical container made of aluminum having an internal diameter of 60 mm and a height of 30 mm. The consolidated toner in the container 216 may have a height of 23 mm.

The container 216 is preferably made of a conductive material so as not to be charged with a toner. Since the container 216 is filled with various kinds of toners, the surface thereof preferably has a mirror-like surface so as not to be contaminated with the toners. The container 216 is required to have a diameter greater than that of a cone rotor 212 so that an inner wall of the container 16 does not affect the cone rotor 212 when the cone rotor 212 intrudes into a bulk of the toner while rotating.

The measurement zone includes the container 216 configured to contain the toner, the elevating stage 218 configured to lift or lower the container 216, a load cell 213 configured to measure a load, and a torque meter 211 configured to measure a torque.

The cone rotor 212 is set to an end of a shaft, and the shaft is fixed so as to be vertically immovable.

The container 216 containing the toner is set on the center of the elevating stage 218. The container 216 is lifted so that the cone rotor 212 intrudes into the center of the container 216 while rotating.

A torque applied to the cone rotor 212 is detected by the torque meter 211 provided above the cone rotor 212, a load applied to the container 216 is detected by the load cell 213 provided below the container 216, and an intrusion distance of the cone rotor 212 is detected by a position detector, not shown. Alternatively, the measurement zone may have another configuration such that the shaft is lifted or lowered by an elevator.

As the torque meter 211, a high-sensitive and non-contact torque meter is preferably used. As the load cell 213, a load cell having a wide loading range and a high resolution is preferably used. As the position detector, a linear scale position detector and a displacement sensor using light can be used. The linear scale detector is capable of feeding back current position information to a drive circuit of a motor of an elevator via an encoder, as a control signal for correcting a current position to a predetermined position. A position detector having a precision of not greater than 0.1 mm is preferable for the evaluation device 210. As the elevator, a servomotor and a stepping motor are preferably used because of their superior driving accuracy.

The cone rotor 212 preferably has a vertical angle of 60°. The generatrix of the cone rotor 212 is required to be long enough so that the conical surface of the cone rotor 212 can be continuously present in the toner. In the present embodiment, the cone rotor 212 has a generatrix of 30 mm.

In order to measure a frictional force between toner particles instead of that between the cone rotor 212 and toner particles, the cone rotor 212 preferably has grooves on the surface thereof. Such a configuration makes toner particles enter into the grooves when the cone rotor 212 intrudes into the toner while rotating. As a result, a frictional force between the toner particles present in the grooves and toner particles surrounding the cone rotor 212 can be measured.

It is to be noted that the shape of the grooves is not particularly limited. However, the contact area of the cone rotor 212 with toner particles is preferably as small as possible.

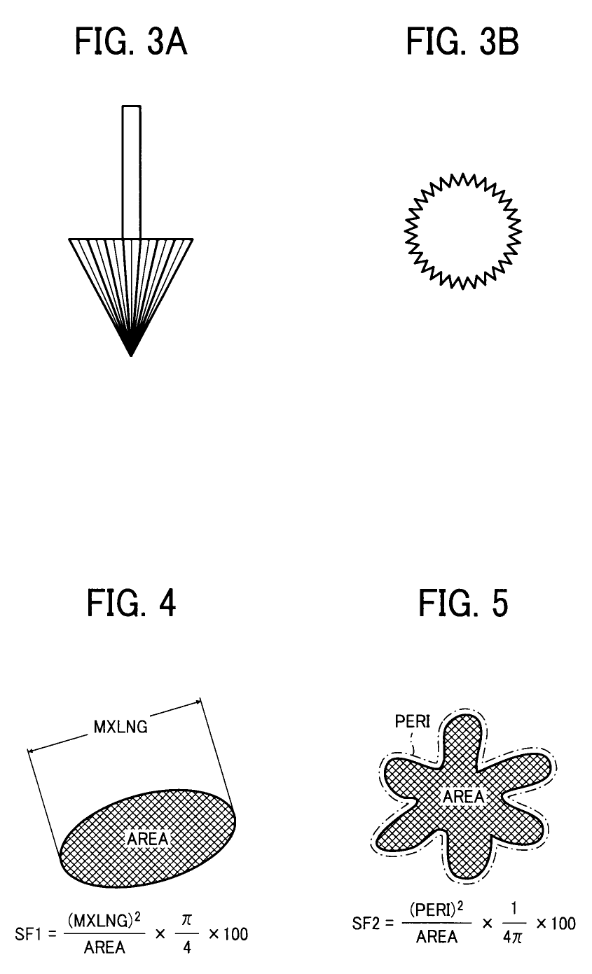

FIGS. 3A and 3B are schematic front and cross-sectional bottom views, respectively, illustrating an embodiment of the cone rotor 212. As illustrated in FIG. 3A, the cone rotor 212 has a vertical angle of 60°, and grooves are formed in straight lines extending from the vertex to the base of the conical part. As illustrated in FIG. 3B, a cross section of the grooves has a sawtooth shape. The generatrix has a length of 30 mm. The depth of the grooves is 0 mm at the vertex and 1 mm at the base, i.e., the grooves gradually deepen from the vertex to the base. There are 48 grooves in the present embodiment.

In the present embodiment, a frictional force between toner particles is measured, instead of a frictional force between the surface of the cone rotor 212 and toner particles.

Specifically, toner particles contact the surface of the cone rotor 212 only at the peaks of the grooves thereof. Most toner particles contact the toner particles present in the valleys of the grooves.

Processible, hard, and non-transmutable materials are preferable for the cone rotor 212. In addition, conductive materials are preferably used. Specific preferred examples of suitable materials include, but are not limited to, SUS, Al, Cu, Au, Ag, and brass. In the present embodiment, the cone rotor 212 is made of Cu.

The fluidity of toner can be evaluated by measuring torque and load generated when the cone rotor 212 intrudes into a bulk of a toner while rotating. Specifically, a torque applied to the cone rotor 212 and a load applied to the container 216 are measured when intruding (pushing down) or drawing (pulling) up the cone rotor 212 into/from the bulk of the toner. The torque and load vary depending on the rotation speed (rpm) and the intrusion speed (mm/min) of the cone rotor 212. In order to precisely measure the torque and load, i.e., to measure a delicate contact among toner particles, the rotation speed and intrusion speed of the cone rotor 212 is preferably as small as possible. For example, the rotation speed is preferably from 0.1 to 100 rpm, and the intrusion speed is preferably from 0.5 to 150 mm/min.

In the present embodiment, the rotation speed of the cone rotor 212 is 1 rpm, the intrusion speed of the cone rotor 212 is 5 mm/min, and a toner is consolidated with a pressure of 585 g/cm² or 1599 g/cm² for 60 seconds. The cone rotor 212 has a vertical angle of 60° (i.e., the rotational axis and the generatrix form an angle of 30°), and 48 grooves are formed on the surface in a circumferential direction. Each of the grooves has a depth of one-fourth of the diameter.

Typically, a toner is mixed with an inorganic or organic external additive such as silica and titanium oxide. Such a toner properly mixed with an external additive provides reliable cleanability. The external additive typically improves fluidity of the toner. Improvement of fluidity means reduction of the friction coefficient between toner particles and the torque applied to the cone rotor.

In the present embodiment, the container 216 is a cylindrical container made of aluminum having an internal diameter of 60 mm and a height of 30 mm. The container 216 is filled with a predetermined amount of a toner so that the consolidated toner has a height of 23 mm, and is set to the evaluation device 210. The container 216 containing the toner is lifted so that the toner contacts the piston 215. Subsequently, the container 216 is further lifted so that all the weight of the weight 214 is applied to the piston 215. In other words, the weight 214 is supported only by the piston 215 while separated from the pedestal 219. After being left for a predetermined time (60 sec), the container 216 is detached from the piston 215 by lowering the elevating stage 218.

When the torque and load are measured, the rotation speed and the intrusion speed of the cone rotor 212 are fixed. The direction of rotation of the cone rotor 212 is not limited. The smaller the intrusion distance of the cone rotor 212, the smaller the torque and load, degrading reproducibility of data measured. In order to obtain highly reproducible data, the cone rotor 212 is preferably intruded as deep as possible. In the present embodiment, the torque is measured when the intrusion distance of the cone rotor 212 is 20 mm.

The measurement can be performed as follows.
(1) filling the container 216 with a toner;
(2) compressing the toner to achieve a consolidated state;
(3) intruding the cone rotor 212 into the toner while rotating, and measuring a torque;
(4) stopping the cone rotor 212 at a predetermined depth (20 mm) from the surface of the toner;
(5) pulling up the cone rotor 212 from the toner; and
(6) stopping movement of the cone rotor 212 when the cone rotor 212 is completely pulled up from the toner and becomes free, i.e., when the cone rotor 212 is returned to the initial position.

The above steps (1) to (6) are repeated, and the measured values are averaged.

The toner of the present invention preferably includes a release agent such as a wax having a low melting point of from 50 to 120° C. The release agent is dispersed in a binder resin in the toner, and facilitates the toner to separate from a fixing roller without applying a release agent such as oil thereto. Specifically, a paraffin wax having a melting point of from 60 to 90° C. is most preferably used.

Specific examples of usable waxes include, but are not limited to, natural waxes such as vegetable waxes (e.g., carnauba wax, cotton wax, Japan wax, rice wax), animal waxes (e.g., beeswax, lanolin), mineral waxes (e.g., ozokerite, ceresin), and petroleum waxes (e.g., paraffin, microcrystalline, petrolatum); synthetic hydrocarbon waxes such as Fischer-Tropsch wax and polyethylene wax; synthetic waxes such as ester, ketone, and ether; fatty acid amides such as 12-hydroxy stearic acid amid, stearic acid amide, phthalic anhydride imide, and halogenated hydrocarbon; and crystalline polymers having a side chain including a long alkyl group such as homopolymers and copolymers of polyacrylates such as poly-n-stearyl methacrylate and poly-n-lauryl methacrylate.

From the viewpoint of preventing the occurrence of the hot offset problem, the toner preferably includes the release agent in as large an amount as possible. By contrast, from the viewpoint of providing reliable charging ability of a carrier, the toner preferably includes the release agent in as small an amount as possible because the release agent easily adheres to the carrier. When the toner includes the release agent in an amount such that an endothermic peak specific to the release agent has an endothermic quantity of from 2.0 to 5.5 J/g, more preferably 3.5 to 5.5 J/g, in an endothermic curve of the toner measured by differential scanning calorimetry (DSC), both prevention of the occurrence of the hot offset problem and provision of reliable charging ability of the carrier can be achieved.

The endothermic curve is measured using instruments TA-60WAS and DSC-60 both from Shimadzu Corporation under the following conditions.

Sample container: Aluminum sample pan with a lid

Sample quantity: 5 mg

Reference: Aluminum sample pan containing 10 mg of alumina

Atmosphere: Nitrogen (flow rate: 50 ml/min)

Temperature conditions:
Start temperature: 20° C.
Temperature rising rate: 10° C./min
End temperature: 150° C.
Retention time: none
Temperature decreasing rate: 10° C./min
End temperature: 20° C.
Retention time: none
Temperature rising rate: 10° C./min
End temperature: 150° C.

Measurement results are analyzed using data analysis software TA-60 version1.52 from Shimadzu Corporation. A DrDSC curve, which is a differential curve of a DSC curve obtained in the second temperature rising scan, is analyzed using a peak analysis function of the software to calculate the endothermic quantity of an endothermic peak corresponding to melting of the release agent, with specifying low-temperature-side and high-temperature-side baselines of the endothermic peak. Among plural endothermic peaks observed in the endothermic curve of a toner, the endothermic peak specific to the release agent can be distinguished by confirming whether or not the endothermic peak is observed at the same temperature at which the endothermic peak is observed in the endothermic curve of the release agent.

In order to determine the glass transition temperature (Tg), first, the DrDSC curve is analyzed using a peak analysis function of the software, with specifying a range of −5° C. to +5° C. around the lowest temperature at which a maximum peak is observed, to determine a peak temperature. Next, the DSC curve is analyzed using the peak analysis function of the software, with specifying a range of −5° C. to +5° C. around the peak temperature, to determine a maximum endothermic temperature. The maximum endothermic temperature thus obtained is defined as the glass transition temperature (Tg).

The toner of the present invention has a Tg of from 40 to 70° C., and more preferably from 40 to 60° C. When the Tg is too low, thermostable preservability of the toner deteriorates. When the Tg is too high, low-temperature fixability of the toner deteriorates. Because including a modified polyester resin such as a urea-modified polyester resin, to be described later, the toner of the present invention has better thermostable preservability than conventional toners using a polyester resin even though the glass transition temperature is relatively low.

The toner of the present invention preferably has an average circularity of from 0.94 to 0.97. The average circularity is measured using a flow-type particle image analyzer FPIA-2000 from Sysmex Corp. and analysis software FPIA-2100 Data Processing Program for FPIA version 00-10. The measurement target is limited to particles having a particle diameter of from 2 to 400 μm.

The toner of the present invention preferably has a shape factor SF-1 of from 130 to 160 and another shape factor SF-2 of from 110 to 140.

FIGS. 4 and 5 are schematic views for explaining the shape factors SF-1 and SF-2, respectively.

As illustrated in FIG. 4, the shape factor SF-1 represents the degree of roundness of a toner particle, and is defined by the following equation (1):

SF-1={(MXLNG)²/(AREA)}×(100π/4) (1)

wherein MXLNG represents the maximum diameter of a projected image of a toner particle to a two-dimensional plane; and AREA represents the area of the projected image.

When the SF-1 is 100, the toner particle has a true spherical shape. The larger SF-1 a toner particle has, the more irregular shape the toner particle has.

As illustrated in FIG. 5, the shape factor SF-2 represents the degree of concavity and convexity of a toner particle, and is defined by the following equation (2):

SF-2={(PERI)²/(AREA)}×(100/4π) (2)

wherein PERI represents the peripheral length of a projected image of a toner particle to a two-dimensional plane; and AREA represents the area of the projected image.

When the SF-2 is 100, the toner particle has no concavity and convexity, i.e., a smooth surface. The larger SF-2 a toner particle has, the rougher surface the toner particle has.

The shape factors SF-1 and SF-2 are determined by the following method. First, 100 toner particles of a toner are photographed using a scanning electron microscope (S-800 manufactured by Hitachi Ltd.). Next, photographic images of the toner particles are analyzed using an image analyzer (LUZEX 3 manufactured by Nireco Corp.) to determine the SF-1 and SF-2.

In order to reliably reproduce microdots with a resolution of 600 dpi or more, the toner of the present invention preferably has a weight average particle diameter (D4) of from 3 to 8 μm. In addition, the ratio (D4/Dn) of the weight average particle diameter (D4) to the number average particle diameter (Dn) is preferably from 1.00 to 1.30. As the ratio (D4/Dn) approaches 1.00, the toner has a narrower particle diameter distribution. For the same reason, the toner of the present invention preferably includes toner particles having a particle diameter of 2 μm or less in an amount of from 1 to 10% by number.

Such a toner having a small particle diameter and a narrow particle diameter distribution has an even charge distribution, providing high quality images without fogging in the background. In addition, such a toner provides high electrostatic transfer efficiency.

On the other hand, a small-sized toner tends to non-electrostatically adhere to a carrier compared to a large-sized toner. Therefore, the small-sized toner may stay on the surface of the carrier for an extended period of time and receive mechanical stress when being agitated. Consequently, the small-sized toner strongly adheres to the surface of the carrier, degrading charging ability of the carrier.

To solve the above-described problem of a small-sized toner, 1 to 10% by number of toner particles having a particle diameter of 2 μm or less are preferably included in the toner.

The particle diameter distribution of a toner can be measured using an instrument such as COULTER COUNTER TA-II and COULTER MULTISIZER II (both from Beckman Coulter K. K.).

A typical measuring method is as follows:
(1) 0.1 to 5 ml of a surfactant (preferably an alkylbenzene sulfonate) is included as a dispersant in 100 to 150 ml of an electrolyte (i.e., 1% NaCl aqueous solution including a first grade sodium chloride, such as ISOTON-II from Coulter Electrons Inc.);
(2) 2 to 20 mg of a toner is added to the electrolyte and dispersed therein using an ultrasonic dispersing machine for about 1 to 3 minutes to prepare a toner suspension liquid;
(3) the weight and number of toner particles in the toner suspension liquid are measured by the above instrument using an aperture of 100 μm to determine the weight and number distributions thereof; and
(4) the weight average particle diameter (D4) and the number average particle diameter (Dn) are determined from the weight and number distributions, respectively.

The following 13 channels are used: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.

Toner particles having a particle diameter of 2.0 μm or less are measured using a flow-type particle image analyzer FPIA-2000 from Sysmex Corp. and analysis software FPIA-2100 Data Processing Program for FPIA version 00-10.

A typical measurement method is as follows:
(1) 0.1 to 0.5 ml of a 10% by weight surfactant (alkylbenzene sulfonate NEOGEN SC-A from Dai-ichi Kogyo Seiyaku Co., Ltd.) is contained in a 100 ml glass beaker, and 0.1 to 0.5 g of a toner is added thereto and mixed using a micro spatula;
(2) 80 ml of ion-exchange water are further added thereto, and the mixture is subjected to a dispersion treatment using an ultrasonic dispersing machine (from Honda Electronics Co., Ltd.) for 3 minutes to prepare a toner suspension liquid including 5,000 to 15,000 per 1 micro-liter of the toner particles; and
(3) the toner suspension liquid is subjected to a measurement using the instrument FPIA 2100.

From the viewpoint of reproducibility of the measurement, it is important that the toner suspension liquid includes 5,000 to 15,000 per 1 micro-liter of toner particles. To prepare such a toner suspension liquid, the amounts of the surfactant and toner may be optimized. The optimum amount of the surfactant depends on hydrophobicity of the toner. When too large an amount of the surfactant is added, bubbles are produced in the toner suspension liquid, causing noise in the measurement. When too small an amount of the surfactant is added, the toner cannot sufficiently be wet, resulting in insufficient dispersion of the toner. The optimum amount of the toner depends on the particle diameter thereof. The smaller the particle diameter, the smaller the optimum amount, and vise versa. When the toner has a particle diameter of from 3 to 7 μm, 0.1 to 0.5 g of the toner is needed to obtain a toner suspension liquid including 5,000 to 15,000 per 1 micro-liter of toner particles.

The toner of the present invention preferably includes a modified polyester (i) as a binder resin. The modified polyester (i) is defined as a polyester resin including a bond other than ester bond, or a polyester resin to which another resin is bonded by a covalent bond or an ionic bond. Specifically, a polyester resin, the ends of which have a functional group such as an isocyanate group that is capable of reacting with a carboxylic acid group and/or a hydroxyl group so as to react with a compound having an active hydrogen, is preferably used as the modified polyester (i).

As the modified polyester (i), a modified polyester obtained from a cross-linking or elongation reaction of a polyester prepolymer having a functional group having a nitrogen atom is preferably used. Specifically, a urea-modified polyester obtained from a reaction between a polyester prepolymer (A) having an isocyanate group and an amine (B) is preferably used. The polyester prepolymer (A) having a nitrogen atom can be obtained from, for example, a reaction between a polyester having an active hydrogen group, which is a polycondensation product of a polyol (PO) with a polycarboxylic acid (PC), and a polyisocyanate compound (PIC). Specific examples of the active hydrogen groups in the polyester include, but are not limited to, hydroxyl groups (including both alcoholic hydroxyl groups and phenolichydroxyl groups), amino group, carboxyl group, and mercapto group. Among these groups, alcoholic hydroxyl groups are preferable.

As the polyol (PO), diols (DIO) and polyols (TO) having 3 or more valences can be used. A diol (DIO) alone, and a mixture of a diol (DIO) with a small amount of a polyol (TO) are preferably used.

Specific examples of usable diols (DIO) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclicdiols (e.g., 1,4-cyclohexanedimethanol, hydrogenated bisphenol A), bisphenols (e.g., bisphenol A, bisphenol F, bisphenol S), alkylene oxide (e.g., ethylene oxide, propylene oxide, butylene oxide) adducts of the above-described alicyclic diols, and alkylene oxide (e.g., ethylene oxide, propylene oxide, butylene oxide) adducts of the above-described bisphenols. Among these compounds, alkylene glycols having 2 to 12 carbon atoms and alkylene oxide adducts of bisphenols are preferably used, and combinations of alkylene oxide adducts of bisphenols with alkylene glycols having 2 to 12 carbon atoms are more preferably used.

Specific examples of usable polyols (TO) having 3 or more valences include, but are not limited to, polyvalent aliphatic alcohols having 3 or more valences (e.g., glycerin, trimethylolethane, trimethylolpropane, pentaerythritol, sorbitol), phenols having 3 or more valences (e.g., trisphenol PA, phenol novolac, cresol novolac), and alkylene oxide adducts of polyphenols having 3 or more valences.

As the polycarboxylic acid (PC), dicarboxylic acids (DIC) and polycarboxylic acids (TC) having 3 or more valences can be used. A dicarboxylic acid (DIC) alone, and a mixture of a dicarboxylic acid (DIC) with a small amount of a polycarboxylic acid (TC) having 3 or more valences are preferably used.

Specific examples of usable dicarboxylic acids (DIC) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalenedicarboxylic acid). Among these compounds, alkenylene dicarboxylic acids having 4 to 20 carbon atoms and aromatic dicarboxylic acids having 8 to 20 carbon atoms are preferably used.

Specific examples of usable polycarboxylic acids (TC) having 3or more valences include, but are not limited to, aromatic polycarboxylic acids having 9 to 20 carbon atoms (e.g., trimellitic acid, pyromellitic acid).

Further, acid anhydrides and lower alkyl esters (e.g., methyl ester, ethyl ester, isopropyl ester) of the above-described compounds maybe reacted with the polyols (PO), to prepare the polycarboxylic acid (PC).

The equivalent ratio ([OH]/[COOH]) of hydroxyl group [OH] of the polyol (PO) to carboxyl group [COOH] of the polycarboxylic acid (PC) is typically from 2/1 to 1/1, preferably from 1.5/1 to 1/1, and more preferably from 1.3/1 to 1.02/1.

Specific examples of usable polyisocyanate compounds (PIC) include, but are not limited to, aliphatic polyisocyanates (e.g., tetramethylene diisocyanate, hexamethylenediisocyanate, 2,6-diisocyanatomethylcaproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above-described polyisocyanates blocked with phenol derivatives, oxime, caprolactam, etc. These compounds can be used alone or in combination.

The equivalent ratio ([NCO]/[OH]) of isocyanate group [NCO] in the polyisocyanate (PIC) to hydroxyl group [OH] in the polyester is typically from 5/1 to 1/1, preferably from 4/1 to 1.2/1, and more preferably from 2.5/1 to 1.5/1. When the equivalent ratio is too large, low-temperature fixability of the resultant toner may deteriorate. When the equivalent ratio is too small, the resultant modified polyester may include too small an amount of urea bonds. Therefore, offset resistance of the resultant toner may deteriorate.

The polyester prepolymer (A) having an isocyanate group typically includes the polyisocyanate compound (PIC) unit in an amount of from 0.5 to 40% by weight, preferably from 1 to 30% by weight, andmore preferably from 2 to 20% by weight. When the content of the polyisocyanate compound (PIC) unit is too small, the resultant toner may have poor hot off set resistance, and may not satisfy thermostable preservability and low-temperature fixability simultaneously. When the content of the polyisocyanate compound (PIC) unit is too large, low-temperature fixability of the resultant toner may be poor.

The number of isocyanate groups included in one molecule of the polyester prepolymer (A) is typically 1 or more, preferably from 1.5 to 3, and more preferably from 1.8 to 2.5. When the number is less than 1, the resultant urea-modified polyester has too small a molecular weight, resulting in poor hot offset resistance.

As the amines (B), diamines (B1), polyamines (B2) having 3 or more valences, amino alcohols (B3), amino mercaptans (B4), amino acids (B5), and blocked amines (B6) in which the amino groups in the amines (B1) to (B5) are blocked, can be preferably used.

Specific examples of usable diamines (B1) include, but are not limited to, aromatic diamines (e.g., phenylenediamine, diethyltoluenediamine, 4,4′-diaminodiphenylmethane), alicyclic diamines (e.g., 4,4′-diamino-3,3′-dimethyldicyclohexylmethane, diamine cyclohexane, isophoronediamine), and aliphatic diamines (e.g., ethylenediamine, tetramethylenediamine, hexamethylenediamine).

Specific examples of usable polyamines (B2) having 3 or more valences include, but are not limited to, diethylenetriamine and triethylenetetramine.

Specific examples of usable amino alcohols (B3) include, but are not limited to, ethanolamine and hydroxyethylaniline.

Specific examples of usable amino mercaptans (B4) include, but are not limited to, aminoethyl mercaptan and aminopropyl mercaptan.

Specific examples of usable amino acids (B5) include, but are not limited to, aminopropionic acid and aminocaproic acid.

Specific examples of usable blocked amines (B6) include, but are not limited to, ketimine compounds prepared by reacting the amines (B1) to (B5) with ketones such as acetone, methyl ethyl ketone, and methyl isobutyl ketone; and oxazoline compounds.

Among these compounds, a diamine (B1) alone, and a mixture of a diamine (B1) with a small amount of a polyamine (B2) are preferably used.

The equivalent ratio ([NCO]/[NHx]) of isocyanate group [NCO] in the polyester prepolymer (A) having an isocyanate group to amino group [NHx] in the amine (B) is typically from 2/1 to 1/1, preferably from 1.5/1 to 1/1.5, and more preferably from 1.2/1 to 1/1.2. When the equivalent ratio is too large or small, the resultant urea-modified polyester may have too small a molecular weight. Therefore, offset resistance of the resultant toner may deteriorate.

The urea-modified polyester may include urethane bond together with urea bond. The molar ratio of the urea bond to the urethane bond is typically from 100/0 to 10/90, more preferably from 80/20 to 20/80, and more preferably from 60/40 to 30/70. When the molar ratio of the urea bond is too small, offset resistance of the resultant toner may deteriorate.

The modified polyester (i) typically has a weight average molecular weight of 10,000 or more, preferably from 20,000 to 10,000,000, and more preferably from 30,000 to 1,000,000. At the same time, the molecular weight distribution of the modified polyester (i) preferably has a peak at a molecular weight of from 1,000 to 10,000 (hereinafter “peak molecular weight”). When the peak molecular weight is too small, the prepolymer hardly elongates. Therefore, the resultant toner may have insufficient elasticity, thereby degrading hot offset resistance. When the peak molecular weight is too large, the resultant toner may have poor low-temperature fixability and manufacturability. When the modified polyester (i) is used in combination with an unmodified polyester (ii) to be described later, the number average molecular weight is not particularly limited. When the modified polyester (i) is used alone, the number average molecular weight thereof is typically 20,000 or less, preferably from 1,000 to 10,000, and more preferably from 2,000 to 8,000. When the number average molecular weight is too large, the resultant toner may have poor low-temperature fixability and the resultant image may have poor glossiness.

The molecular weight of the resultant urea-modified polyester can be controlled by using a reaction terminator for terminating the cross-linking and/or elongation reaction, if desired. Specific examples of usable reaction terminators include, but are not limited to, monoamines (e.g., diethylamine, dibutylamine, butylamine, laurylamine) and blocked compounds thereof (e.g., ketimine compounds).

As described above, the toner of the present invention may include an unmodified polyester (ii) in combination with the modified polyester (i). In this case, the resultant toner may have good low-temperature fixability and the resultant full-color image may have high glossiness. As the unmodified polyester (ii), polycondensation products of the above-described polyol (PO) with the above-described polycarboxylic acid (PC) are preferably used. The unmodified polyester (ii) may have a bond other than urea bond, such as urethane bond. From the viewpoint of improving low-temperature fixability and hot offset resistance simultaneously, it is preferable that the modified polyester (i) and the unmodified polyester (ii) are at least partially soluble with each other. Therefore, the modified polyester (i) and the unmodified polyester (ii) preferably have a similar composition. The weight ratio ((i)/(ii)) of the modified polyester (i) to the unmodified polyester (ii) is typically from 5/95 to 80/20, preferably from 5/95 to 30/70, more preferably from 5/95 to 25/75, and much more preferably from 7/93 to 20/80. When the ratio ((i)/(ii)) is too small, the resultant toner may have poor hot off set resistance, and may not satisfy thermostable preservability and low-temperature fixability simultaneously.

The unmodified polyester (ii) typically has a peak molecular weight of from 1,000 to 5,000, preferably from 2,000 to 8,000, and more preferably from 2,000 to 5,000. When the peak molecular weight is too small, hot offset resistance of the resultant toner may deteriorate. When the peak molecular weight is too large, low temperature fixability of the resultant toner may deteriorate. The unmodified polyester (ii) preferably has a hydroxyl value of 5 or more, more preferably from 10 to 120, and much more preferably from 20 to 80. When the hydroxyl value is too small, the resultant toner may not satisfy thermostable preservability and low-temperature fixability simultaneously. The unmodified polyester (ii) preferably has an acid value of from 1 to 5, and more preferably from 2 to 4.

From the viewpoint of improving low-temperature fixability and hot offset resistance simultaneously, the binder resin preferably has a glass transition temperature (Tg) of from 40 to 60° C. When the Tg is too low, hot offset resistance of the resultant toner may deteriorate. When the Tg is too high, low-temperature fixability of the resultant toner may deteriorate. Since the urea-modified polyester tends to present at the surface of the resultant toner, the toner of the present invention has better thermostable preservability than conventional toners including polyester resins, even though the glass transition temperature is low.

Specific examples of colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials can be used alone or in combination. The toner typically includes the colorant in an amount of from 1 to 15% by weight, and preferably from 3 to 10% by weight.

The colorant for use in the present invention can be combined with a resin to be used as a master batch. Specific examples of the resin for use in the master batch include, but are not limited to, polymers of styrenes or substitutions thereof (e.g., polystyrene, poly-p-chlorostyrene, and polyvinyl toluene), copolymers of styrenes with vinyl compounds, polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin, and paraffin wax. These resins can be used alone or in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

Specific examples of usable charge controlling agent include, but are not limited to, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surfactants, metal salts of salicylic acid, and metal salts of salicylic acid derivatives.

Specific examples of commercially available charge controlling agents include, but are not limited to, BONTRON® N-03 (Nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as sulfonate group, carboxyl group, and a quaternary ammonium group. In particular, materials capable of negatively charging the resultant toner are preferably used.

The content of the charge controlling agent is determined depending on the species of the binder resin used, and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity, thereby increasing the electrostatic force of a developing roller attracting the toner, resulting in deterioration of fluidity of the toner and image density of the toner images.

The toner of the present invention may include an inorganic filler so as to control the shape. As the inorganic filler, montmorillonite and organically-modified products thereof (such as CLAYTONE® APA) are preferably used. The inorganic filler has a function of forming concavities and convexities on the surface of a toner particle, the mechanism of which is considered as follows.

In a toner manufacture process in which a toner constituent liquid including an organic solvent and an inorganic filler is emulsified in an aqueous medium in the presence of a surfactant and a particulate resin, the inorganic filler migrates to the interface between the organic solvent and the aqueous medium at the time of emulsification. As a result, the inorganic filler gathers at the surfaces of the droplets in the emulsification dispersion. The organic solvent is then removed from the droplets in the emulsification dispersion, followed by washing and drying. Consequently, the inorganic filler is present at the surface of the resultant particles forming concavities and convexities. The shape of toner of the present invention can be appropriately controlled when 0.1 to 10 parts by weight of the inorganic filler is included per 100 parts by weight of the binder resin. The greater the content of the inorganic filler, the greater the shape factors SF-1 and SF-2. The greater the shape factors SF-1 and SF-2, the greater the torque.

Typically, chargeability of a toner particle largely depends on the amount of a chargeable substance present at the surface of the toner particle. Since the above-described inorganic filler, such as montmorillonite and an organically-modified product thereof, has chargeability, a toner particle including a large amount of the inorganic filler at the surface thereof has satisfactory chargeability. Particularly, a layered inorganic mineral such as montmorillonite has a great function of not only forming concavities and convexities on the surface of a toner particle, but also enhancing chargeability of the toner particle.

To improve fluidity, chargeability, and chargeability, a particulate inorganic material (hereinafter “external additive”) is preferably externally added to the toner of the present invention. The particulate inorganic material preferably has a primary particle diameter of from 5×10⁻³ to 0.3 μm, and a BET specific surface area of from 100 to 500 m²/g. The toner preferably includes the particulate inorganic material in an amount of from 0.01 to 5% by weight, and more preferably from 0.01 to 2.0% by weight.

Specific examples of usable inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

In addition, fine particles of polymers can also be used such as polystyrene, which is manufactured by a soap-free emulsion polymerization method, a suspension polymerization method, or a dispersion polymerization method; copolymers of methacrylates and acrylates; polycondensation resins such as silicone resin, benzoguanamine resin, and nylon; and thermoplastic resins.

The external additive may be surface-treated so as to improve hydrophobicity. In this case, fluidity and chargeability of the resultant toner may not deteriorate even in high-humidity conditions. As the surface-treatment agent, silane coupling agents, silylation agents, silane coupling agents having a fluorinated alkyl group, organic titanate coupling agents, aluminum coupling agents, silicone oils, and modified silicone oils.

In particular, a hydrophobized silica and a hydrophobized titanium oxide are preferably used, which are obtained by the surface treatment of silica and titanium oxide, respectively.

Next, a preferable method of manufacturing the toner of the present invention will be described in detail.

A binder resin can be prepared as follows. First, a polyol (PO) and a polycarboxylic acid (PC) are heated to 150 to 280° C. in the presence of an esterification catalyst such as tetrabutoxy titanate and dibutyltin oxide, while removing the produced water under a reduced pressure, if desired, to obtain a polyester having hydroxyl group. The polyester is then reacted with a polyisocyanate compound (PIC) at from 40 to 140° C. so that a prepolymer (A) having an isocyanate group is obtained. The prepolymer (A) is further reacted with an amine (B) at 0 to 140° C. so that a urea-modified polyester (i) is obtained.

At the time the polyester is reacted with the polyisocyanate compound (PIC) or the prepolymer (A) is reacted with the amine (B), a solvent can be used, if desired. Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetoamide), and ethers (e.g., tetrahydrofuran). These solvents are inert to the polyisocyanate compound (PIC).

An unmodified polyester (ii) can be prepared by a similar way to the preparation of the urea-modified polyester (i), if desired. The unmodified polyester (ii) may be mixed into the reacted liquid containing the urea-modified polyester (i).

The toner of the resent invention may include the urea-modified polyester (i) as a binder resin by mixing with other toner constituents. Alternatively, the toner of the present invention is preferably prepared by dispersing toner constituents including a low-molecular-weight prepolymer having an isocyanate group on its ends in an aqueous medium, while subjecting the prepolymer to an elongation and/or cross-linking reaction with an amine, to form toner particles including a urea-modified polyester.

The following is a description of an example method of manufacturing the toner of the present invention.

(1) First, a colorant, a polyester, the polyester prepolymer (A) having an isocyanate group, a release agent, etc. are dissolved or dispersed in an organic solvent to prepare a toner constituent liquid. Preferably, the polyester prepolymer (A) having an isocyanate group, the unmodified polyester (ii), a colorant, a paraffin wax, and an organic filler is dissolved or dispersed in an organic solvent to prepare a toner constituent liquid. Volatile solvents having a boiling point of less than 100° C. are preferably used because of being easily removable from the resultant toner particles. Specific examples of usable organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These organic solvents can be used alone or in combination. Among these organic solvents, aromatic solvents such as toluene and xylene and halogenated hydrocarbons such as 1,2-dichloroethane, chloroform, carbon tetrachloride are preferably used. The content of the organic solvent is typically from 25 to 300 parts by weight, preferably from 25 to 100 parts by weight, and more preferably from 25 to 70 parts by weight.

(2) The toner constituent liquid is emulsified in an aqueous medium in the presence of a surfactant and a particulate resin. As the aqueous medium, water alone or a mixture of water with an organic solvent such as an alcohol (e.g., methanol, isopropyl alcohol, ethylene glycol), dimethylformamide, tetrahydrofuran, and a cellosolve (e.g., methyl cellosolve) can be used.

The amount of the aqueous medium is typically from 50 to 2000 parts by weight, and preferably from 100 to 1,000 parts by weight, per 100 parts by weight of the toner constituent liquid. When the amount of the aqueous medium is too small, the toner constituent liquid may not be dispersed well, and therefore desired-sized particles cannot be obtained. When the amount of the aqueous medium is too large, it is economically insufficient.

The particulate resin included in the aqueous medium preferably has a glass transition temperature (Tg) of from 50 to 110° C., and more preferably from 50 to 90° C. When the Tg is too small, thermostable preservability of the resultant toner may deteriorate, possibly causing clogging due to adhesion or aggregation of the toner in a toner collection path when being recycled. When the Tg is too large, the particulate resin may inhibit fixation of the toner on a recording paper, thereby increasing the minimum fixable temperature of the toner. Much more preferably, the particulate resin has a Tg of from 50 to 70° C.

The particulate resin preferably has a weight average molecular weight of 100,000 or less and more preferably 50,000 or less, and 4,000 or more. When the weight average molecular weight is too large, the particulate resin may inhibit fixation of the toner on a recording paper, thereby increasing the minimum fixable temperature of the toner.

Known resins capable of forming an aqueous dispersion thereof can be used for the particulate resin. For example, both thermoplastic and thermosetting resins such as vinyl resins, polyurethane resins, epoxy resins, and polyester resins can be used. These resins can be used alone or in combination. The above-described resins, i.e., vinyl resins, polyurethane resins, epoxy resins, polyester resins, and mixtures thereof are preferably used because an aqueous dispersion of fine spherical particles thereof is easily obtainable.

Specific examples of usable vinyl resins include, but are not limited to, homopolymers and copolymers of vinyl monomers such as styrene-acrylate copolymers, styrene-methacrylate copolymers, styrene-butadiene copolymers, acrylic acid-acrylate copolymers, methacrylic acid-acrylate copolymers, styrene-acrylonitrile copolymers, styrene-maleic anhydride copolymers, styrene-acrylic acid copolymers, and styrene-methacrylic acid copolymers.

The particulate resin typically has a volume average particle diameter of from 10 to 200 nm, and preferably from 20 to 80 nm, measured by a light scattering spectrophotometer (from Otsuka Electronics Co., Ltd.).

The aqueous medium further contains a surfactant. The surfactant and particulate resin both serve as a dispersant to form a stable dispersion.

Specific examples of usable surfactants include, but are not limited to, anionic surfactants such as alkylbenzene sulfonates, α-olefin sulfonates, and phosphates; cationic surfactants such as amine salts (e.g., alkylamine salts, amino alcohol aliphatic acid derivatives, polyamine aliphatic acid derivatives, imidazoline) and quaternary ammonium salts (e.g., alkyl trimethyl ammonium salts, dialkyl dimethyl ammonium salts, alkyl dimethyl benzyl ammonium salts, pyridinium salts, alkyl isoquinolinium salts, benzethonium chloride); nonionic surfactants such as aliphatic acid amide derivatives and polyvalent alcohol derivatives; and ampholytic surfactants such as alanine, dodecyl di(aminoethyl)glycine, di(octyl aminoethyl)glycine, and alkyl-N,N-dimethyl ammonium betaine.

Surfactants having a fluoroalkyl group are effective even in small amounts. Specific preferred examples of usable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4)sulfonic acid sodium, 3-[ω-fluoroalkanoyl(C6-C8)-N-ethylamino]-1-propane sulfonic acid sodium, fluoroalkyl(C11-C20)carboxylic acids and metal salts thereof, perfluoroalkyl(C7-C13)carboxylic acids and metal salts thereof, perfluoroalkyl(C4-C12)sulfonic acids and metal salts thereof, perfluorooctane sulfonic acid dimethanol amide, N-propyl-N-(2-hydroxyethyl)perfluorooctane sulfonamide, perfluoroalkyl(C6-C10)sulfonamide propyl trimethyl ammonium salts, perfluoroalkyl(C6-C10)-N-ethyl sulfonyl glycine salts, and monoperfluoroalkyl(C6-C16)ethyl phosphates.

Specific examples of usable commercially available anionic surfactants having a fluoroalkyl group include, but are not limited to, SARFRON® S-111, S-112 and S-113 (manufactured by Asahi Glass Co., Ltd.); FLUORAD® FC-93, FC-95, FC-98 and FC-129 (manufactured by Sumitomo 3M Ltd.); UNIDYNE® DS-101 and DS-102 (manufactured by Daikin Industries, Ltd.); MEGAFACE® F-110, F-120, F-113, F-191, F-812 and F-833 (manufactured by Dainippon Ink and Chemicals, Inc.); ECTOP® EF-102, 103, 104, 105, 112, 123A, 123B, 306A, 501, 201 and 204 (manufactured by Tochem Products Co., Ltd.); and FUTARGENT® F-100 and F-150 (manufactured by Neos).

Specific preferred examples of usable cationic surfactants having a fluoroalkyl group include, but are not limited to, aliphatic primary, secondary, and tertiary amine acids having a fluoroalkyl group, aliphatic tertiary ammonium salts such as perfluoroalkyl(C6-C10)sulfonamide propyl trimethyl ammonium salts, benzalkonium salts, benzethonium chloride, pyridinium salts, and imidazolinium salts.

Specific examples of usable commercially available cationic surfactants include, but are not limited to, SARFRON® S-121 (manufactured by Asahi Glass Co., Ltd.); FLUORAD® FC-135 (manufactured by Sumitomo 3M Ltd.); UNIDYNE® DS-202 (manufactured by Daikin Industries, Ltd.); MEGAFACE® F-150 and F-824 (manufactured by Dainippon Ink and Chemicals, Inc.); ECTOP® EF-132 (manufactured by Tohchem Products Co., Ltd.); and FUTARGENT® F-300 (manufactured by Neos).

The particulate resin has functions of stabilizing the aqueous dispersion of the resultant toner and preventing the release agent from being exposed at the surface of the resultant toner. The particulate resin is added in an appropriate amount so that the particulate resin covers from 10 to 90% of the surface area of the toner.

Specific examples of usable particulate resins include, but are not limited to, a particulate poly(methyl methacrylate) with a diameter of 1μm or 3 μm, particulate styrene with a diameter of 0.5 μm or 2 μm, and a particulate styrene-acrylonitrile polymer with a diameter of 1 μm. Specific examples of usable commercially available particulate polymers include, but are not limited to, PB-200H (from Kao Corporation), SGP (from Soken Chemical & Engineering Co., Ltd.), TECHPOLYMER SB (from Sekisui Plastics Co., Ltd.), SGP-3G (from Soken Chemical & Engineering Co., Ltd.), and MICROPEARL (from Sekisui Chemical Co., Ltd.).

In addition, inorganic dispersants such as tricalcium phosphate, calcium carbonate, titanium oxide, colloidal silica, hydroxyapatite can also be used.

Polymeric protection colloids may be used in combination with the above-described particulate resins and inorganic dispersants to form a stable dispersion.

Specific examples of the polymeric protection colloids include, but are not limited to, homopolymers and copolymers of monomers such as acid monomers (e.g., acrylic acid, methacrylic acid, α-cyanoacrylic acid, α-cyanomethacrylic acid, itaconic acid, crotonic acid, fumaric acid, maleic acid, maleic anhydride), (meth)acrylic monomers having hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, N-methylol methacrylamide), vinyl alcohols and ethers of vinyl alcohols (e.g., vinyl methyl ether, vinyl ethyl ether, vinyl propyl ether), esters of vinyl alcohols with compounds having carboxyl group (e.g., vinyl acetate, vinyl propionate, vinyl butyrate), monomers having amide bond (e.g., acrylamide, methacrylamide, diacetoneacrylamide acid) and methylol compounds thereof, acid chloride monomers (e.g., acrylic acid chloride, methacrylic acid chloride), and monomers having a nitrogen atom or a heterocyclic ring having a nitrogen atom (e.g., vinyl pyridine, vinyl pyrrolidone, vinyl imidazole, ethylene imine); polyoxyethylene resins (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonyl phenyl ethers, polyoxyethylene lauryl phenyl ethers, polyoxyethylene stearyl phenyl esters, polyoxyethylene nonyl phenyl esters); and cellulose compounds (e.g., methyl cellulose, hydroxyethyl cellulose, hydroxypropyl cellulose).

Any known dispersing machines such as low-speed shearing type, high-speed shearing type, friction type, high pressure jet type, and ultrasonic type can be used for the dispersion. In order to prepare a dispersion including particles having an average particle diameter of from 2 to 20 μm, a high-speed shearing type dispersing machine is preferably used. When high-speed shearing type dispersing machines are used, the rotation speed of rotors is typically from 1,000 to 30,000 rpm, and preferably from 5,000 to 20,000 rpm, but not limited thereto. The dispersing time is typically from 0.1 to 5 minutes in batch type dispersing machines, but not limited thereto. The temperature in the dispersing process is typically from 0 to 15° C. (under pressure), and preferably from 40 to 98° C.

(3) At the time of the emulsification, the amine (B) is added so as to be reacted with the polyester prepolymer (A) having an isocyanate group.

In the reaction, molecular chains are cross-linked and/or elongated. The reaction time is typically from 10 minutes to 40 hours, and preferably from 2 to 24 hours, however, it depends on the structure of the isocyanate group of the polyester prepolymer (A) and the reactivity thereof with the amine (B) The reaction temperature is typically from 0 to 150° C., and preferably from 40 to 98° C. A catalyst such as dibutyltin laurate and dioctyltin laurate can be used.

(4) After the reaction is terminated, the organic solvent is removed from the dispersion (emulsion), followed by washing and drying, so that toner particles are obtained.

To remove the organic solvent, the reaction system is gradually heated while being agitated under a laminar flow. If the reaction system is strongly agitated at a certain temperature, the resultant toner particles may have a spindle shape. If calcium phosphate, which is soluble in acids and bases, is used as a dispersion stabilizer, the calcium phosphate maybe removed by being dissolved in an acid such as hydrochloric acid, followed by washing with water. Alternatively, the dispersion stabilizer may be removed by decomposition using enzymes.

(5) A charge controlling agent and a particulate inorganic material such as silica and titanium oxide are externally added to the toner particles thus obtained by a known method such as using a mixer.

A toner having a small particle diameter and a narrow particle diameter distribution is easily obtained by the above-described method. By strongly agitating the reaction system when the organic solvent is removed therefrom, the resultant toner particles can be deformed from a spherical shape to a rugby-ball-like shape. In addition, the surface of the resultant toner particles may be controlled to be either smooth or rough.

The toner of the present invention is used for either a one-component developer or a two-component developer in which the toner is mixed with a carrier.

As the carrier, generally known carriers such as ferrites, magnetites, and resin-coated carriers can be used. Preferably, a ferrite (serving as a core) having the following formula and an average particle diameter of from 20 to 40 μm, the surface of which is covered with a resin layer in which fine particles are dispersed, is used:

(MgO)ₓ(MnO)_{y}(Fe₂O₃)_{z}

wherein x represents an integer of from 1 to 5, y represents an integer of from 45 to 55, and z represents an integer of from 45 to 55.

The core may include other components such as impurities, substitutions, and additives, for example, SnO₂, SrO, alkaline-earth metal oxides, Bi₂O₅, ZrO, etc.

The carrier generally has two functions of conveying a toner to a developing area in a developing device and charging the toner, both owing to agitation of the carrier with the toner. A carrier with the above-described configuration has good fluidity, thereby evenly conveying a toner, providing reliable developability.

The developed toner may form an even layer, and such an even layer may be reliably transferred, providing reliable transferability.

In addition, the carrier with the above-described configuration provides consistent developability regardless of the kind of a toner used.

Specific examples of usable resins for covering the core include acrylic resins and silicone resins, but are not limited thereto. A carrier in which such resins and the core described above are combined is capable of reliably and evenly conveying and charging a toner.

Acrylic resins express excellent abrasion resistance because of having strong adhesion property and low brittleness. On the other hand, the acrylic resins also have high surface energy. Therefore, a toner may easily adhere to and accumulate thereon, decreasing charge thereof. To prevent adhesion of toner to the carrier, silicone resins are preferably used in combination with the acrylic resins. Since the silicone resins have low surface energy, a toner hardly adhere to and accumulate thereon. In contrast to the acrylic resins, the silicone resins express poor abrasion resistance because of having weak adhesion property and high brittleness. It is important to balance these acrylic and silicone resins to obtain a cover layer having abrasion resistance to which a toner hardly adheres.

Specifically, a cover layer including 10 to 90% by weight of an acrylic resin, and a silicone resin has excellent property. When the amount of the acrylic resin is too small, the cover layer includes too large an amount of the silicone resin, thereby degrading abrasion resistance due to high brittleness of the silicone resin. By contrast, when the amount of the acrylic resin is too large, the cover layer includes too large an amount of the acrylic resin having high surface energy, thereby causing adhesion and accumulation of a toner to/on the cover layer.

The acrylic resins for use in the present invention include all resins including an acrylic component. An acrylic resin alone or a combination of an acrylic resin with another component capable of crosslinking, such as amino resins and acid catalysts, can be used. Specific examples of usable amino resins include guanamine resins and melamine resins, but are not limited thereto. Specific examples of usable acid catalysts include all catalyst having catalysis, for example, catalysts having a reactive group, such as completely-alkylated group, methylol group, imino group, and methylol-imino group.

The silicone resins for use in the present invention include all silicone resins generally known, such as straight silicone resins consisting of organosiloxane bonds and modified silicone resins modified with an alkyd, a polyester, epoxy, acryl, or urethane, but are not limited thereto.

Specific examples of useable commercially available straight silicone resins include, but are not limited to, KR271, KR255, and KR152 (from Shin-Etsu Chemical Co., Ltd.); and SR2400, SR2406, and SR2411 (from Dow Corning Toray Silicone Co., Ltd.). In this case, a silicone resin alone or a combination of a silicone resin with another component capable of crosslinking or a charge controlling component can be used. Specific examples of useable commercially available modified resins include, but are not limited to, KR206 (alkyd-modified), KR5208 (acryl-modified), ES1001 (epoxy-modified), and KR305 (urethane-modified) (from Shin-Etsu Chemical Co., Ltd.); and SR2115 (epoxy-modified) and SR2110 (alkyd-modified) (from Dow Corning Toray Silicone Co., Ltd.).

A cover layer including an acrylic resin and a silicone resin with a layered structure has more excellent property. A single material having all functions required for carrier, such as resistance to toner adhesion, resistance to abrasion, and adhesion property, does not exist. Therefore, plural materials each having a single function required for carrier are typically used in combination. Specifically, an acrylic resin layer is preferably formed between a core and a silicone resin layer so as to strongly adhere the silicone resin layer to the core, and the silicone resin layer, to which a toner hardly adheres, is preferably formed on the acrylic resin layer.

Specific examples of usable fine particles dispersed in the cover layer include, but are not limited to, alumina, titanium oxide, zinc oxide, and these materials which are surface-treated. These materials can be used alone or in combination. Among these materials, alumina is preferably used from the viewpoint of charging a negatively-chargeable toner.

A purpose of dispersing the fine particles in the cover layer is to protect the cover layer from an external force applied to the surface of the carrier. If the fine particles are easily broken or abraded due to the external force, the cover layer may not be consistently protected. The above-described fine particles each have high toughness and are hardly broken or abraded, thereby protecting the cover layer for an extended period of time. The fine particles preferably have a particle diameter of 5 μm or less. The fine particles are preferably dispersed in the acrylic resin layer, because the acrylic resin is capable of holding the fine particles for an extended period of time due to its strong adhesion property.

The cover layer may include a carbon black, if desired. The carbon black can be used as a resistivity decreasing agent both in a cover layer consisting of a resin and that including a resin and fine particles. When a high-resistivity carrier is used for a developer, an image with high definition is produced in which the image density of the center part is extremely low and that of the edge is high (hereinafter “edge effect”). When an original image includes texts and thin lines, the produced image may have high definition due to the edge effect. By contrast, when an original image is a half-tone image, the produced image may have poor reproducibility. By including an appropriate amount of a carbon black in the cover layer of the carrier, high quality images can be produced. Such a carrier can be also used for a full-color developer.

In some cases, such a cover layer including a carbon black is scraped off and the fragments thereof may be immixed in the resultant full-color image. The resultant full-color image may be an abnormal image because such a cover layer expresses a strong color of the carbon black. In the present invention, since the cover layer includes an acrylic resin having strong adhesion property and abrasion resistance, as described above, the carbon black can be strongly held in the cover layer and the cover layer itself is hardly scraped off. Therefore, the carbon black hardly releases from the carrier. According to the above-described layered structure of the cover layer, preferably, the carbon black is included in the lower acrylic resin layer, and no carbon black is included in the upper silicone resin layer. As the carbon black used for the present invention, all carbon blacks generally used for toners can be used. On the other hand, if the silicone resin layer with high brittleness, which is easily scraped off, includes the carbon black, a defect image including the black fragments of the scraped cover layer may be produced.

The carrier for use in the present invention can be manufactured by, for example, dispersing a resin and fine particles in a solvent to prepare a cover layer coating liquid, and applying the cover layer coating liquid to the surface of a core, followed by drying.

The two-component developer preferably includes the toner in an amount of from 3 to 12% by weight. The image density is controlled by controlling the toner density in the developer. Specifically, the toner and the carrier are mixed so that 100% or less of the surface area of the carrier is covered with the toner. In this case, the toner and the carrier can sufficiently contact with each other, thereby charging the toner sufficiently.

The developer of the present invention can be used for a process cartridge integrally supporting a photoreceptor and a developing device, and optionally a charging device and a cleaning device. The process cartridge is detachably attachable to an image forming apparatus such as a copier and a printer.

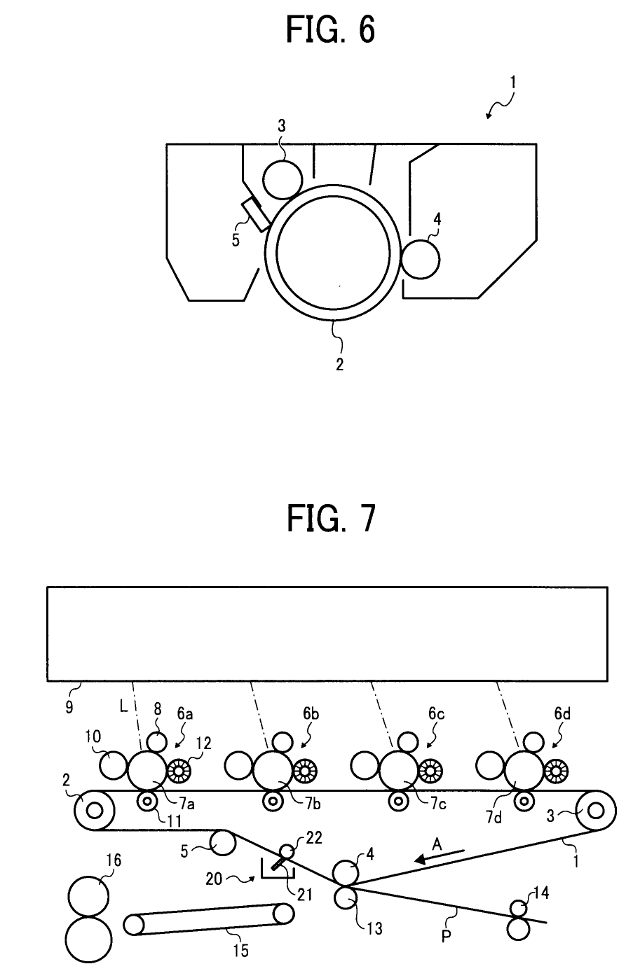

FIG. 6 is a schematic view illustrating an embodiment of a process cartridge containing the developer of the present invention. A process cartridge 1 includes a photoreceptor 2, a charging device 3, a developing device 4, and a cleaning device 5.

Operation of an image forming apparatus to which the above-described process cartridge is attached is as follows.

The photoreceptor 2 is driven to rotate at a predetermined rotation speed. A surface of the photoreceptor 2 is evenly charged to a predetermined positive or negative voltage by the charging device 3 while rotating, and then exposed to a light beam containing image information emitted from an irradiator, such as a slit irradiator and a laser beam scanning irradiator, to form an electrostatic latent image thereon. The electrostatic latent image is developed with a toner by the developing device 4 to form a toner image. The toner image is then transferred onto a transfer material which is conveyed from a paper feed part to between the photoreceptor 2 and a transfer device in synchronization with rotation of the photoreceptor 2. The transfer material having the toner image thereon separates from the surface of the photoreceptor 2, and conveyed to a fixing device to fix the toner image on the transfer material. Thus, a copying material is discharged out of the image forming apparatus. The surface of the photoreceptor 2 from which the toner image has been transferred is cleaned by the cleaning device 5, to remove residual toner particles which are not transferred but remain on the surface of the photoreceptor 2. Further, electricity is removed therefrom to prepare for a next image forming operation.

Next, an image forming apparatus of the present invention will be described in detail.

FIG. 7 is a schematic view illustrating an embodiment of a full-color image forming apparatus according to illustrative embodiments of the present invention. A full-color image forming apparatus illustrated in FIG. 7 includes an image forming part. The image forming part includes an intermediate transfer belt 1 serving as an intermediate transfer member. The intermediate transfer belt 1 is wound around rollers 2, 3, 4, and 5. One of the rollers 2 or 3 drives to rotate clockwise so that the intermediate transfer belt 1 is driven to move in a direction indicated by arrow A in FIG. 7. The image forming part further includes image forming units 6a, 6b, 6c, and 6d facing an upper moving surface of the intermediate transfer belt 1. The image forming units 6a, 6b, 6c, and 6d include drum-shaped photoreceptors 7a, 7b, 7c, and 7d each serving as an image bearing member, respectively. Magenta, cyan, yellow, and black toner images are formed on the photoreceptors 7a, 7b, 7c, and 7d, respectively.

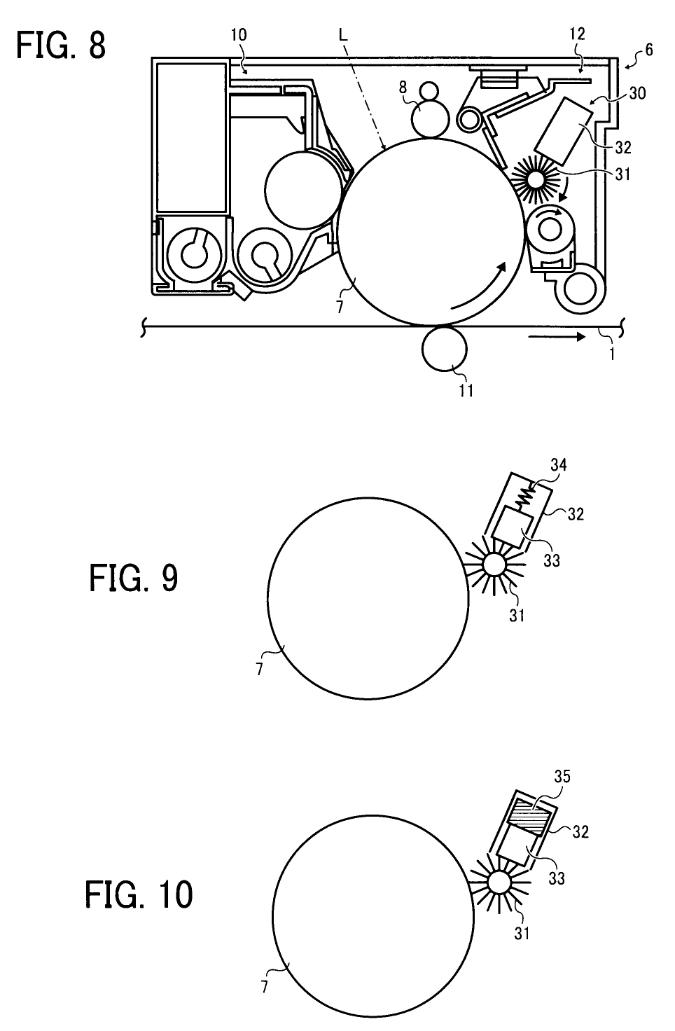

FIG. 8 is a schematic view illustrating an embodiment of the image forming unit 6a. Since the image forming units 6a, 6b, 6c, and 6d have substantially the same configuration and function, only one image forming unit 6a will be described in detail, and therefore in FIG. 8 the letter “a” is omitted from the reference number.

Referring to FIG. 8, the photoreceptor 7 is driven to rotate counterclockwise. A charging roller 8 charges a surface of the photoreceptor 7 to a predetermined polarity. The charged surface is then exposed to an optically modulated laser beam L emitted from a laser writing unit 9 illustrated in FIG. 7. As a result, an electrostatic latent image is formed on the photoreceptor 7. The electrostatic latent image is then formed into a visible toner image, i.e., a magenta toner image, by a developing device 10.

A voltage having a polarity opposite to that of the toner is applied to a transfer roller 11, disposed facing the photoreceptor 7 with the intermediate transfer belt 1 therebetween, so that the magenta toner image formed on the photoreceptor 7 is transferred onto the intermediate transfer belt 1. Residual toner particles remaining on the photoreceptor 7 without being transferred onto the intermediate transfer belt 1 are removed by a cleaning device 12.

Referring back to FIG. 7, in a similar way, cyan, yellow, and black toner images are formed on the photoreceptors 7b, 7c, and 7d of the image forming units 6b, 6c, and 6d, respectively. The cyan, yellow, and black toner images are successively transferred and superimposed onto the magenta toner image that is previously transferred onto the intermediate transfer belt 1, to form a composite toner image (hereinafter simply “toner image”). The toner image thus formed on the intermediate transfer belt 1 is then conveyed to a secondary transfer part, in which a secondary transfer roller 13 is provided, in association with the movement of the intermediate transfer belt 1.

A paper feed part, not shown, is provided below the image forming part. The paper feed part feeds a recording material P, such as paper, to a registration roller 14. The registration roller 14 feeds the recording material P to the secondary transfer part in synchronization with an entry of the toner image formed on the intermediate transfer belt 1 into the secondary transfer part. A voltage having a polarity opposite to that of the toner is applied to the secondary transfer roller 13 so that the toner image on the intermediate transfer belt 1 is transferred onto the recording material P. The recording material P onto which the toner image is transferred is conveyed to a fixing device 16 by a conveyance belt 15 so that the toner image is fixed on the recording material P. The recording material P on which the toner image is fixed is discharged to a discharge part, not shown.

Residual toner particles remaining on the intermediate transfer belt 1 without being transferred onto the recording material P are removed by a belt cleaning device 20. The belt cleaning device 20 includes a cleaning blade 21 abrasively contacting the intermediate transfer belt 1. A backup roller 22 is provided facing the cleaning blade 21 with the intermediate transfer belt 1 therebetween so as to ensure reliable abrasive contact of the cleaning blade 21 with the intermediate transfer belt 1.

In some cases, a part of the toner image is not transferred from the photoreceptor 7 onto the intermediate transfer belt 1. Consequently, an image with defects is produced. The inventors of the present invention found that the occurrence of the above-described phenomenon can be prevented when the photoreceptor 7 has a lower surface friction coefficient than the intermediate transfer belt 1.

A pattern used for controlling the adhesion amount of toner or correcting positional deviation is sometimes formed at an interval of image formation. Since the pattern is not to be transferred onto the recording material P, part or all of the pattern may be transferred onto the surface of the secondary transfer roller 13. Therefore, a cleaning device for cleaning the secondary transfer roller 13 is needed. Although a cleaning blade is typically used as the cleaning device, the cleaning blade has a drawback of easily deforming, possibly interfering with or stopping altogether the rotation of the secondary transfer roller 13.

The occurrence of such a deformation of the cleaning blade can be prevented by controlling the surface friction coefficient of a cleaning target (i.e., the intermediate transfer belt 1 or the secondary transfer roller 13). In particular, it is effective to set the surface friction coefficient of the secondary transfer roller 13 lower than that of the intermediate transfer belt 1.

A lubricant applicator configured to apply a lubricant to each of the photoreceptor 7, the intermediate transfer belt 1, and the secondary transfer roller 13 is preferably provided.

The intermediate transfer belt 1 itself can be formed as follows: First, a carbon black is dispersed in a solution of polyamic acid. The resultant polymer dispersion is poured into a cylindrical metallic mold, and the cylindrical metallic mold is then rotated while being heated to 100 to 200° C. so as to form a film by centrifugal molding, followed by drying. The resultant film, which is partially hardened, is peeled off from the cylindrical metallic mold, and wrapped around an iron core while being heated to 300 to 450° C. so as to become a completely hardened polyimide film. The resultant endless polyimide film is cut into an appropriate size to obtain the intermediate transfer belt 1. The resistivity of the belt can be controlled by varying the amount of the carbon black, the heating temperature, the hardening time, etc. The belt thus formed has a surface friction coefficient of 0.45. The surface friction coefficient can be measured using an instrument HEIDON TRIBOGEAR μS 94i from Shinto Scientific Co., Ltd.

A lubricant applicator according to illustrative embodiments of the present invention will now be described in detail with reference to FIG. 8. In FIG. 8, a lubricant applicator 30 configured to apply a lubricant to the photoreceptor 7 is provided. Of course, the lubricant applicator 30 is also applicable to the intermediate transfer belt 1 or the secondary transfer roller 13.

The lubricant applicator 30 is disposed within the cleaning device 12, and includes an application brush 31 and a lubricant unit 32. As illustrated in FIG. 9, the lubricant unit 32 includes a solid lubricant 33 and a spring 34 configured to press the solid lubricant 33 against the application brush 31. The application amount of the solid lubricant 33 is variable by varying the force of the spring 34 on the solid lubricant 33. Alternatively, the spring 34 can be replaced with a weight 35, as illustrated in FIG. 10. The application amount of the solid lubricant 33 can be varied by varying the weight of the weight 35.

By independently providing the lubricant applicator 30 to each of the photoreceptor 7, the intermediate transfer belt 1, and the secondary transfer roller 13, the surface friction coefficients thereof can be appropriately set. Accordingly, the surface friction coefficient of the intermediate transfer belt 1 can be set larger than those of the photoreceptor 7 and the secondary transfer roller 13.

As described above, the lubricant applicator 30 can be independently provided to each of the photoreceptor 7, the intermediate transfer belt 1, and the secondary transfer roller 13. Alternatively, the lubricant applicator 30 is independently provided to each of the photoreceptor 7 and the secondary transfer roller 13 while no lubricant applicator is provided to the intermediate transfer belt 1, so that the lubricant is indirectly applied to the intermediate transfer belt 1 via the photoreceptor 7 and the secondary transfer roller 13. In this case, a smaller amount of the lubricant is applied to the intermediate transfer belt 1 compared to the photoreceptor 7 and the secondary transfer roller 13, thereby easily setting the surface friction coefficient of the intermediate transfer belt 1 larger than those of the photoreceptor 7 and the secondary transfer roller 13.

In order to set the surface friction coefficient of the intermediate transfer belt 1 larger than those of the photoreceptor 7 and the secondary transfer roller 13, alternatively, a surface layer may be provided on the photoreceptor 7 for the purpose of reducing the surface friction coefficient thereof.

Specific examples of usable materials for the surface layer of the photoreceptor 7 include, but are not limited to, styrene-acrylonitrile copolymers, styrene-butadiene copolymers, acrylonitrile-butadiene-styrene copolymers, olefin-vinyl monomer copolymers, chlorinated polyether resins, aryl resins, phenol resins, polyacetal resins, polyamide resins, polyamide-imide resins, polyacrylate resins, polyallylsulfone resins, polybutylene resins, polybutylene terephthalate resins, polycarbonate resins, polyethersulfone resins, polyethylene resins, polyethylene terephthalate resins, polyimide resins, acrylic resins, polymethylpentene resins, polypropylene resins, polyphenylene oxide resins, polysulfone resins, polyurethane resins, polyvinyl chloride resins, polyvinylidene chloride resins, and epoxy resins.

Fine particles of a fluorocarbon resin, a polyolefin resin, a silicone resin, etc., are mixed with the above-described resin to reduce the surface friction coefficient.

Specific examples of usable fluorocarbon resins for the fine particles include, but are not limited to, polymers and copolymers of tetrafluoroethylene, hexafluoropropylene, trifluoroethylene, chlorotrifluoroethylene, vinylidene fluoride, vinyl fluoride, and perfluoroalkyl vinyl ether.

Specific examples of usable polyolefin resins for the fine particles include, but are not limited to, homopolymers of an olefin such as ethylene, propylene, butene, etc. (e.g., polyethylene, polypropylene, polybutene, polyhexene), copolymers of the olefins (e.g., ethylene-propylene copolymer, ethylene-butene copolymer, ethylene-propylene-hexene copolymer), and thermal denaturation products thereof.

Specific examples of usable silicone resins for the fine particles include, but are not limited to, silicone resins insoluble in organic solvents in which siloxane bonds form a three-dimensional network structure and silicon atoms are substituted with an alkyl group, an aryl group, an amino-substituted alkyl group, or a dialkyl silicone.

The photoreceptor having such a surface layer typically has a surface friction coefficient of from 0.1 to 0.3.

The surface friction coefficient of the intermediate transfer belt 1 depends on the surface roughness thereof, and is typically 0.35 to 0.7.

A combination of the above-described photoreceptor 7 with a lower surface friction coefficient and the above-described intermediate transfer belt 1 with a higher surface friction coefficient provides high transfer efficiency without producing images with defects.

Further, provision of the lubricant applicator 30 to the secondary transfer roller 13 makes the surface friction coefficient of the secondary transfer roller 13 smaller than that of the intermediate transfer belt 1, preventing deformation of the cleaning blade.

The inventors of the present invention studied how the difference in surface friction coefficient between the photoreceptor 7 and the intermediate transfer belt 1 affects a possibility of producing image with defects, and found that the degree of production of images with defects is within the allowable extent so long as the photoreceptor 7 has a smaller surface friction coefficient than the intermediate transfer belt 1. The surface friction coefficients of the photoreceptor 7 and the intermediate transfer belt 1 are adjusted by varying the amount of the lubricant applied thereto. The application amount of the lubricant is adjusted by varying the force with which the solid lubricant is pressed against the application target. Alternatively, a length of time or an area of contact of the lubricant applicator with the application target can be varied to adjust the application amount of the lubricant.

The inventors of the present invention further studied how the difference in surface friction coefficient between the photoreceptor 7 and the intermediate transfer belt 1 affects transfer efficiency, and found that the smaller the surface friction coefficient of the photoreceptor 7 than that of the intermediate transfer belt 1, the higher the transfer efficiency.

Accordingly, by making the surface friction coefficient of the photoreceptor 7 smaller than that of the intermediate transfer belt 1, production of images with defects is prevented and the transfer efficiency is improved. Such a relation in the surface friction coefficient can be achieved applying less lubricant to the photoreceptor 7 than to the intermediate transfer belt 1.

Further, the inventors of the present invention studied a relation between each of the surface friction coefficients of the intermediate transfer belt 1 and the secondary transfer roller 13 and the occurrence of deformation of the cleaning blade. The surface friction coefficients of the intermediate transfer belt 1 and the secondary transfer roller 13 are set to the same value by adjusting the application amount of a lubricant thereto, and images are then continuously produced. As a result, the cleaning blade more easily deforms when cleaning the secondary transfer roller 13 than when cleaning the intermediate transfer belt 1. In addition, the cleaning blade more easily deforms as the surface friction coefficient of the cleaning target increases. Moreover, the cleaning blade starts deforming earlier when cleaning the secondary transfer roller 13 than when cleaning the intermediate transfer belt 1. It is apparent from these results that the cleaning blade more easily deforms when cleaning the secondary transfer roller 13 than when cleans the intermediate transfer belt 1. Accordingly, in order to prevent deformation of the cleaning blade when cleaning the secondary transfer roller 13, the surface friction coefficient of the secondary transfer roller 13 is preferably set smaller than that of the intermediate transfer belt 1. Therefore, setting the surface friction coefficient of the intermediate transfer belt 1 to a value sufficient to prevent deformation of the cleaning blade for cleaning the intermediate transfer belt 1 is also effective to prevent deformation of the cleaning blade for cleaning the secondary transfer roller 13.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Toner Manufacturing Example 1

### (Preparation of Particulate Resin Emulsion)

In a reaction vessel equipped with a stirrer and a thermometer, 683 parts of water, 11 parts of a sodium salt of sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and a part of ammonium persulfate are contained, and agitated for 30 minutes at a revolution of 3,800 rpm. Thus, a whitish emulsion is prepared. The emulsion is heated to 75° C. and reacted for 4 hours. Subsequently, 30 parts of a 1% aqueous solution of ammonium persulfate are added to the emulsion, and aged for 8 hours at 75° C. Thus, a particulate resin dispersion (1), which is an aqueous dispersion of a vinyl resin (i.e., a copolymer of styrene, methacrylic acid, butyl acrylate, and a sodium salt of sulfate of ethylene oxide adduct of methacrylic acid), is prepared. Particles of the vinyl resin in the particulate resin dispersion (1) have a volume average particle diameter of 110 nm, measured by a Particle Size Distribution Analyzer LA-920 from Horiba. Ltd. A part of the particles is dried, and the dried particles have a glass transition temperature (Tg) of 58° C. and a weight average molecular weight of 130,000.

### (Preparation of Aqueous Medium)

To prepare an aqueous medium, 990 parts of water, 83 parts of the particulate dispersion (1), 37 parts of a 48.3% aqueous solution of dodecyl diphenyl ether disulfonic acid sodium (ELEMINOL MON-7 from Sanyo Chemical Industries, Ltd.), and 90 parts of ethyl acetate are mixed and agitated. Thus, an aqueous medium (1), which is a milky liquid, is prepared.

### (Preparation of Low-Molecular-Weight Polyester)

In a reaction vessel equipped with a condenser, a stirrer, and a nitrogen inlet pipe, 724 parts of ethylene oxide 2 mol adduct of bisphenol A and 276 parts of terephthalic acid are contained. The mixture is subjected to a polycondensation reaction for 7 hours at 230° C. at normal pressures, and subsequently for 5 hours under a reduced pressure of from 10 to 15 mmHg. Thus, a low-molecular-weight polyester (1) having a peak molecular weight of 3,800, a Tg of 43° C., and an acid value of 4 mgKOH/g is prepared.

### (Preparation of Intermediate Polyester)

In a reaction vessel equipped with a condenser, a stirrer, and a nitrogen inlet pipe, 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide are contained. The mixture is subjected to a reaction for 7 hours at 230° C. at normal pressures, and subsequently for 5 hours under a reduced pressure of from 10 to 10 mmHg. Thus, an intermediate polyester (1) having a number average molecular weight of 2,200, a weight average molecular weight of 9,700, a peak molecular weight of 3,000, a Tg of 54° C., an acid value of 0.5 mgKOH/g, and a hydroxyl value of 52 mgKOH/g is prepared.

Next, in a reaction vessel equipped with a condenser, a stirrer, and a nitrogen inlet pipe, 410 parts of the intermediate polyester (1), 89 parts of isophorone diisocyanate, and 500 parts of ethyl acetate are contained, and reacted for 5 hours at 100° C. Thus, a prepolymer (1) is prepared. The prepolymer (1) includes free isocyanate in an amount of 1.53% by weight.

### (Preparation of Ketimine)

In a reaction vessel equipped with a stirrer and a thermometer, 170 parts of isophoronediamine and 75 parts of methyl ethyl ketone are contained, and reacted for 4.5 hours at 50° C. Thus, a ketimine compound (1) having an amine value of 417 is prepared.

### (Preparation of Master Batch)

First, 1,200 parts of water, 540 parts of a carbon black (PRINTEX 35 from Evonik Degussa Japan, having a DBP oil absorption value of 42 ml/100 mg and a pH of 9.5), and 1,200 parts of a polyester resin are mixed using a HENSCHEL MIXER (from Mitsui Mining Co., Ltd.). The mixture is kneaded for 1 hour using a double-roll mill at 130° C., and the kneaded mixture is then roller and cooled. The rolled and cooled mixture is pulverized using a pulverizer. Thus, a master batch (1) is prepared.

### (Preparation of Colorant-Wax Dispersion)

In a reaction vessel equipped with a stirrer and a thermometer, 378 parts of the low-molecular-weight polyester (1), 100 parts of a paraffin wax having a melting point of 70° C., and 947 parts of ethyl acetate are contained, and heated to 89° C. while being agitated. The mixture is kept at 80° C. for 5 hours and cooled to 30° C. over a period of 1 hour. Next, 500 parts of the master batch (1), 30 parts of an organic modified montmorillonite (CLAYTON® APA from Southern Clay Products, Inc.), and 500 parts of ethyl acetate are contained in a vessel, and mixed for 1 hour. Thus, a raw material liquid (1) is prepared.

Next, 1324 parts of the raw material liquid (1) are contained in another vessel, and subjected to a dispersion treatment using a bead mill (ULTRAVISCOMILL (trademark) from Aimex Co., Ltd.). The dispersing conditions are as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Further, 1324 parts of a 65% ethyl acetate solution of the low-molecular-weight polyester (1) are added thereto, and the mixture is subjected to the same dispersion treatment described above except for reducing the repeat number of dispersion operation to twice (2 passes). Thus, a colorant-wax dispersion (1) is prepared. The colorant-wax dispersion contains solid components in an amount of 50%.

### (Emulsification)

In a vessel, 749 parts of the colorant-wax dispersion (1), 115 parts of the prepolymer (1), and 2.9 parts of the ketimine compound (1) are contained, and mixed for 2 minutes using a TK KOMOMIXER (from Tokushu Kika Kogyo Co., Ltd.) for 1 minute at a revolution of 5,000 rpm. Further, 1,200 parts of the aqueous medium (1) are added thereto, and the mixture is mixed using the TK HOMOMIXER for 25 minutes at a revolution of 13,000 rpm. Thus, an emulsion slurry (1) is prepared.

### (Solvent Removal)

The emulsion slurry (1) is contained in a vessel equipped with a stirrer and a thermometer, and subjected to solvent removal for 7 hours at 30° C. Thus, a dispersion slurry (1) is prepared.

### (Washing and Drying)

Next, 100 parts of the dispersion slurry (1) is filtered under a reduced pressure to obtain a wet cake.

The wet cake thus obtained is mixed with 100 parts of ion-exchange water, and the mixture is agitated for 10 minutes using a TK HOMOMIXER at a revolution of 12,000 rpm, followed by filtering. Thus, a wet cake (i) is prepared.

The wet cake (i) is mixed with 100 parts of a 10% aqueous solution of sodium hydroxide, and the mixture is agitated for 10 minutes using a TK HOMOMIXER at a revolution of 12,000 rpm, followed by filtering under a reduced pressure. Thus, a wet cake (ii) is prepared.

The wet cake (ii) is mixed with 100 parts of 10% hydrochloric acid, and the mixture is agitated for 10 minutes using a TK HOMOMIXER at a revolution of 12,000 rpm, followed by filtering. Thus, a wet cake (iii) is prepared.

The wet cake (iii) is mixed with 300 parts of ion-exchange water, and the mixture is agitated for 10 minutes using a TK HOMOMIXER at a revolution of 12,000 rpm, followed by filtering. This operation is repeated twice. Thus, a wet cake (1) is prepared.

The wet cake (1) is dried for 48 hours at 45° C. using a circulating air drier, followed by sieving with a screen having openings of 75 μm. Thus, a mother toner (1) is prepared.

Next, 100 parts of the mother toner (1) is mixed with 1 part of a hydrophobized silica (having a BET specific surface area of 140 m²/g) and 1 part of a hydrophobized titanium oxide (having a BET specific surface area of 75 m²/g) using a HENSCHEL MIXER. Thus, a toner (1) is prepared.

### Toner Manufacturing Example 2

The procedure for preparation of the toner (1) is repeated except that the amount of the organic modified montmorillonite is changed from 30 parts to 0 part. Thus, a toner (2) is prepared.

### Toner Manufacturing Example 3

The procedure for preparation of the toner (1) is repeated except that 100 parts of the paraffin wax having a melting point of 70° C. are replaced with 100 parts of a carnauba wax having a melting point of 70° C. Thus, a toner (3) is prepared.

### Toner Manufacturing Example 4

The procedure for preparation of the toner (1) is repeated except that the amount of the organic modified montmorillonite is changed from 30 parts to 0 part, and 100 parts of the paraffin wax having a melting point of 70° C. are replaced with 100 parts of another paraffin wax having a melting point of 110° C. Thus, a toner (4) is prepared.

### Toner Manufacturing Example 5

The procedure for preparation of the toner (1) is repeated except that the amount of the organic modified montmorillonite is changed from 30 parts to 0 part, and 100 parts of the paraffin wax having a melting point of 70° C. are replaced with 100 parts of a carnauba wax having a melting point of 70° C. Thus, a toner (5) is prepared.

### Toner Manufacturing Example 6

The procedure for preparation of the toner (1) is repeated except that the amount of the organic modified montmorillonite is changed from 30 parts to 48 parts. Thus, a toner (6) is prepared.

### Toner Manufacturing Example 7

The procedure for preparation of the toner (1) is repeated except that the amount of the organic modified montmorillonite is changed from 30 parts to 12 parts. Thus, a toner (7) is prepared.

### Toner Manufacturing Example 8

The procedure for preparation of the toner (1) is repeated except that the amount of the paraffin wax having a melting point of 70° C. is changed from 100 parts to 150 parts. Thus, a toner (8) is prepared.

### Toner Manufacturing Example 9

The procedure for preparation of the toner (1) is repeated except that the amount of the paraffin wax having a melting point of 70° C. is changed from 100 parts to 75 parts. Thus, a toner (9) is prepared.

### Toner Manufacturing Example 10

The procedure for preparation of the toner (1) is repeated except that the low-molecular-weight polyester (1) is replaced with a low-molecular-weight polyester (2). Thus, a toner (10) is prepared.

The low-molecular-weight polyester (2) is prepared as follows. In a reaction vessel equipped with a condenser, a stirrer, and a nitrogen inlet pipe, 690 parts of ethylene oxide 2 mol adduct of bisphenol A and 335 parts of terephthalic acid are contained. The mixture is subjected to a polycondensation reaction for 10 hours at 210° C. at normal pressures under nitrogen airflow, and subsequently for 5 hours under a reduced pressure of from 10 to 15 mmHg while removing the produced water, followed by cooling. Thus, a low-molecular-weight polyester (2) having a weight average molecular weight of 6,000, a Tg of 55° C., and an acid value of 20 mgKOH/g is prepared.

### Toner Manufacturing Example 11

The procedure for preparation of the toner (1) is repeated except that the revolution of the TK HOMOMIXER is increased so that the particle diameter of the resultant toner particles are reduced. Thus, a toner (11) is prepared.

### Toner Manufacturing Example 12

The procedure for preparation of the toner (1) is repeated except that the revolution of the TK HOMOMIXER is increased so that the particle diameter of the resultant toner particles are reduced. Thus, a toner (12) is prepared.

### Toner Manufacturing Example 13

The procedure for preparation of the toner (1) is repeated except that the amount of the organic modified montmorillonite is changed from 30 parts to 55 parts. Thus, a toner (13) is prepared.

The average circularity, the shape factors SF-1 and SF-2, the weight average particle diameter (D4), the ratio (D4/Dn) of the weight average particle diameter (D4) to the number average particle diameter (Dn), the amount of the endothermic peak specific to the wax measured by DSC, the glass transition temperature (Tg), the content of fine particles having a particle diameter of 2 μm or less, and the torque of each of the toners (1) to (13) are shown in Tables 1-1 and 1-2.

The torque is measured using the device illustrated in FIG. 2. Each of the toners is consolidated with a load of 585 g/cm² or 1599 g/cm2 for 60 seconds to prepare a bulk of the toner. The cone rotor has a vertical angle of 60°, a rotation speed of 1 rpm, and an intrusion speed 5 mm/min. The torque is measured when the cone rotor intrudes into the bulk of the toner for a depth of 20 mm.

TABLE 1-1

| | | | | | | Content of Fine |
|---|---|---|---|---|---|---|
| | Average | | | D4 | | Particles (*) |
| Toner | Circularity | SF-1 | SF-2 | (μm) | D4/Dn | (% by number) |
| 1 | 0.960 | 149 | 120 | 5.8 | 1.20 | 6 |
| 2 | 0.986 | 128 | 109 | 5.9 | 1.21 | 8 |
| 3 | 0.962 | 146 | 119 | 5.8 | 1.17 | 6 |
| 4 | 0.988 | 126 | 108 | 5.7 | 1.15 | 7 |
| 5 | 0.987 | 128 | 108 | 5.8 | 1.19 | 8 |
| 6 | 0.945 | 156 | 138 | 5.8 | 1.24 | 8 |
| 7 | 0.970 | 133 | 113 | 5.8 | 1.22 | 7 |
| 8 | 0.961 | 146 | 122 | 5.7 | 1.20 | 7 |
| 9 | 0.960 | 147 | 124 | 5.8 | 1.20 | 6 |
| 10 | 0.962 | 146 | 118 | 5.6 | 1.22 | 8 |
| 11 | 0.961 | 142 | 126 | 5.8 | 1.21 | 8 |
| 12 | 0.961 | 152 | 126 | 5.8 | 1.31 | 12 |
| 13 | 0.938 | 162 | 141 | 5.8 | 1.24 | 8 |

(*) Content of fine particles having a particle diameter of 2 μm or less

TABLE 1-2

| | Endothermic | | | |
|---|---|---|---|---|
| | Peak | Tg | Torque 1(*) | Torque 2(**) |
| Toner | (J/g) | (° C.) | (mNm) | (mNm) |
| 1 | 3.8 | 52 | 1.7 | 1.9 |
| 2 | 4.0 | 48 | 1.3 | 1.5 |
| 3 | 4.2 | 50 | 1.5 | 1.6 |
| 4 | 3.8 | 50 | 1.2 | 1.4 |
| 5 | 4.1 | 50 | 1.1 | 1.2 |
| 6 | 3.8 | 49 | 1.9 | 2.8 |
| 7 | 3.8 | 49 | 1.5 | 1.6 |
| 8 | 6.0 | 50 | 1.8 | 2.1 |
| 9 | 2.9 | 50 | 1.6 | 1.9 |
| 10 | 4.0 | 48 | 1.6 | 1.8 |
| 11 | 3.7 | 49 | 1.6 | 1.9 |
| 12 | 3.0 | 50 | 1.6 | — |
| 13 | 3.8 | 49 | 2.1 | — |

Torque 1(*): a toner is consolidated with a load of 585 g
Torque 2(**): a toner is consolidated with a load of 1599 g

### Preparation of Developers

Each of the toners (1) to (13) is mixed with a carrier (1) prepared below so that the total amount of the toner and the carrier becomes 1 kg and the toner concentration becomes 3% by weight and 12% by weight, respectively. The mixing is performed for 10 minutes using a TURBULA® MIXER at a maximum agitation strength.

The carrier (1) is prepared as follows. First, 21.0 parts of an acrylic resin solution (including 50% by weight of solid components), 6.4 parts of a guanamine solution (including 70% by weight of solid components), 7.6 parts of alumina particles (having a particle diameter of 0.3 μm and resistivity of 10¹⁴ Ω·cm), 65.0 parts of a silicone resin solution (including 23% by weight of solid components, SR2410 from Dow Corning Toray Co., Ltd.), 0.3 parts of an aminosilane (including 100% byweight of solid components, SH6020 from Dow Corning Toray Co., Ltd.), 60 parts of toluene, and 60 parts of butyl cellosolve are mixed for 10 minutes using a HOMOMIXER. Thus, a coating liquid for forming an acrylic/silicone blended resin cover layer including alumina particles is prepared. The coating liquid is applied to the surface of a core material, which is a calcined ferrite ((MgO)_{1.8}(MnO)_{49.5}(Fe₂O₃)_{48.0}) powder having an average particle diameter of 35 μm, using a SPIRA COTA® (from Okada Seiko Co., Ltd.), followed by drying. Thus, a cover layer having a thickness of 0.15 μm is formed on the core material. The core material on the surface of which the cover layer is formed is calcined in an electric furnace for 1 hour at 150° C., followed by cooling, and then sieved with a mesh having openings of 106 μm. Thus carrier (1) is prepared. The thickness of the cover layer can be measured by observing of a cross-section of the carrier with a transmission electron microscope.

### Evaluation 1 (Fixability)

Each of the developers prepared above is set in a copier MF2200 (from Ricoh Co., Ltd.) in which a fixing part employing a fixing roller using TEFLON® is modified. An unfixed rectangular solid image with a short side of 2 cm and a long side of 7 cm and having 1.0 mg/cm² of the toner thereon is formed on sheets of a paper TYPE 6200 (from Ricoh Co., Ltd.).

Each of the sheets having the unfixed image is fixed changing the temperature of the fixing roller at intervals of 5° C. to determine a minimum fixable temperature below which a cold offset occurs and a hot offset temperature at and above which a hot offset occurs. When the minimum fixable temperature is determined, the fixing roller has a paper feed speed of 120 mm/sec, a surface pressure of 1.2 Kgf/cm², and a nip width of 3 mm. When the hot offset temperature is determined, the fixing roller has a paper feed speed of 50 mm/sec, a surface pressure of 2.0 Kgf/cm², and a nip width of 4.5 mm.

### Evaluation 2 (Deterioration in Charging Ability of Carrier)

Each of the developers including 3% by weight and 12% by weight of the toner, respectively, prepared above is set in a digital full-color copier IMAGIO COLOR 2800 (from Ricoh Co., Ltd.), and 30,000 sheets of a monochrome image chart in which 50% of a total area is occupied with images are continuously produced at 25° C. and 50% RH. Thereafter, a part of the developer is taken out of the copier to measure the charge by a blow off method. The degree of deterioration in charging ability of the carrier is evaluated by comparing the charge amount thereof before and after 30,000 sheets of the image chart are produced, and graded as follows.

Good: The decrement is less than 5 μC/g.

Average: The decrement is from 5 to 10 μC/g.

Poor: The decrement is greater than 10 μC/g.

The results of Evaluations 1 and 2 are shown in Table 2.

TABLE 2

| | | | Deterioration in Charging | |
|---|---|---|---|---|
| | Fixability | | Ability of Carrier | |
| | Minimum Fixable | Hot Offset | Toner | Toner |
| | Temperature | Temperature | Concentration: | Concentration: |
| Toner | (° C.) | (° C.) | 3% by weight | 12% by weight |
| 1 | 140 | 200 | Good | Good |
| 2 | 140 | 200 | Average | Poor |
| 3 | 140 | 175 | Good | Good |
| 4 | 140 | 180 | Good | Good |
| 5 | 140 | 175 | Good | Good |
| 6 | 140 | 200 | Good | Good |
| 7 | 140 | 200 | Good | Average |
| 8 | 140 | 210 | Average | Poor |
| 9 | 140 | 175 | Good | Good |
| 10 | 155 | 200 | Good | Good |
| 11 | 140 | 195 | Good | Good |
| 12 | 140 | 195 | Good | Average |
| 13 | 140 | 200 | Good | Good |

### Evaluation 3 (Cleanability)

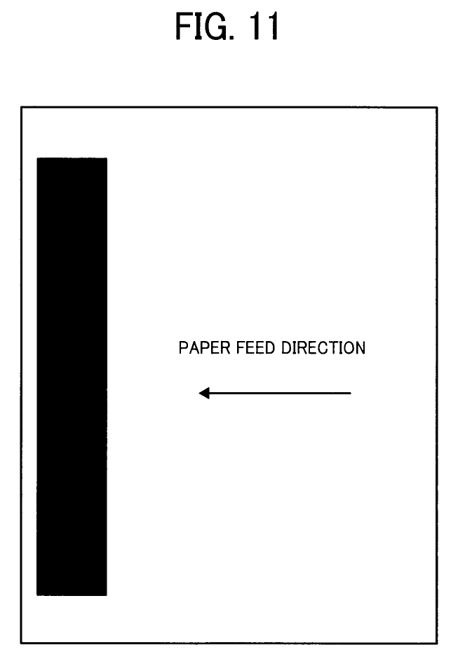

Cleanability is evaluated as follows.
(1) The toners prepared above and an image forming apparatus IMAGIO NEO C600 (having a configuration illustrated in FIG. 7) are kept in an environmental chamber of 25° C. and 50% RH for 1 day.
(2) Toner contained in a commercially available PCU of IMAGIO NEO C600 is removed therefrom so that only carrier remains in the developing device.
(3) 28 g of each of the toner prepared above is set in the developing device containing the carrier so that 400 g of a developer including 7% by weight of the toner are prepared.
(4) The developing device containing the developer thus prepared is mounted on the IMAGIO NEO C600, and the developing device is idly driven for 5 minutes with a linear speed of the developing sleeve of 300 m/s or 330 m/s.
(5) Both the developing sleeve and the photoreceptor are rotated at a linear speed of 300 m/s so as to trail with each other, and a developing bias is adjusted so that the photoreceptor bears the toner in an amount of 0.6±0.05 mg/cm².
(6) The cleaning blade in the commercially available PCU of IMAGIO NEO C600, having an elastic modulus of 70% and a thickness of 2 mm, is contacted the photoreceptor at an angle of contact of 20° so as to face in the direction of rotation of the photoreceptor.
(7) A transfer current is adjusted so that the transfer efficiency becomes 96±2%.
(8) Under the above-described conditions, 1,000 sheets of a chart having a band-like image with a length of 4 cm in a paper feed direction and a length of 25 cm in a width direction, as illustrated in FIG. 11, are produced.
(9) The last sheet is visually observed whether or not an abnormal image is produced in center portions in both the paper feed direction and in the width direction, that is, a back ground portion.
(10) The image density is evaluated by measuring the v value of the produced image using X-RITE 938 (from X-Rite).
(11) The cleanability is evaluated by comparing the image density of the background portion before and after the image is produced, and graded as follows.

Good: The image density of the background portion is 0.01 or less after the image is produced.

Poor: The image density of the background portion is greater than 0.01 after the image is produced.

The results of Evaluation 3 are shown in Table 3.

TABLE 3

Cleanability

| | Linear Speed: | Linear Speed: |
|---|---|---|
| Toner | 300 m/s | 330 m/s |
| 1 | Good | Good |
| 2 | Poor | Poor |
| 3 | Good | Poor |
| 4 | Poor | Poor |
| 5 | Poor | Poor |
| 6 | Good | Poor |
| | | (Undesirable toner film is formed.) |
| 7 | Good | Poor |
| 8 | Good | Poor |
| | | (Undesirable toner film is formed.) |
| 9 | Good | Good |
| 10 | Good | Good |
| 11 | Good | Good |

### Evaluation 4 (Cleanability and Transfer Efficiency)

To study how the difference in surface friction coefficient between the photoreceptor and the intermediate transfer belt influence upon the transfer efficiency, Evaluation 3 described above is repeated except that the surface friction coefficients of the photoreceptor and the intermediate transfer belt are varied, as described in Table 4, by changing the amount of a lubricant applied thereto. The amount of the lubricant applied to each of the photoreceptor and the intermediate transfer belt is changed by changing a pressing force of the solid lubricant to the target.

The transfer efficiency is evaluated by the degree of production of images with defects, and graded into three levels (poor/average/good).

In Evaluation 4, the photoreceptor and the intermediate transfer belt are visually observed to evaluate cleanability, and graded into two levels (poor/good).

TABLE 4

| | | Difference | | | |
|---|---|---|---|---|---|
| | | in Surface | | Cleanability | Cleanability |
| | | Friction | Transfer | of | of |
| | | Coefficient | Effi- | Photo- | Intermediate |
| | Toner | (*) | ciency | receptor | Transfer Belt |
| Example 1 | 1 | 0.03 | Good | Good | Good |
| Comparative | 2 | 0.03 | Good | Good | Poor |
| Example 1 | | | | | |
| Comparative | 1 | −0.03 | Poor | Good | Good |
| Example 2 | | | | | |
| Comparative | 2 | −0.03 | Average | Poor | Poor |
| Example 3 | | | | | |
| Comparative | 13 | 0.03 | Poor | Good | Good |
| Example 4 | | | | | |

(*) (Surface Friction Coefficient of Intermediate Transfer Belt)
− (Surface Friction Coefficient of Photoreceptor)

This document claims priority and contains subject matter related to Japanese Patent Applications Nos. 2007-308505 filed on Nov. 29, 2007, 2007-310513 filed on Nov. 30, 2007, and 2007-310512 filed on Nov. 30, 2007, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising;
a binder resin; and
a colorant,
wherein the toner produces a torque of from 1.4 to 2.0 mNm when a cone rotor having a vertical angle of 60° and grooves on a surface thereof intrudes into a bulk of the toner at an intrusion speed of 5 mm/min for a depth of 20 mm while rotating at a rotation speed of 1 rpm, wherein the bulk of the toner is formed by consolidating 30 g of the toner in a cylindrical container having an internal diameter of 60 mm for 60 seconds with a consolidation load of 585 g.

2. The toner according to claim 1, further comprising a paraffin wax having a melting point of from 60 to 90° C.,
wherein the toner has an endothermic peak in an amount of from 2.0 to 5.5 J/g in an endothermic curve measured by differential scanning calorimetry (DSC), and
wherein the toner has an average circularity of from 0.94 to 0.97.

3. The toner according to claim 2, wherein the toner is manufactured by a method comprising:
dissolving or dispersing toner constituents comprising a polyester prepolymer having a functional group having a nitrogen atom, a polyester, the colorant, the paraffin wax, and an inorganic filler in an organic solvent, to prepare a toner constituent liquid; and
dispersing the toner constituent liquid in an aqueous medium while subjecting the polyester prepolymer to at least one of a cross-linking reaction or an elongation reaction to prepare the toner,
wherein the toner has a shape factor SF-1 of from 130 to 160 and a shape factor SF-2 of from 110 to 140.

4. The toner according to claim 3, wherein the inorganic filler is a montmorillonite or a modified montmorillonite.

5. The toner according to claim 2, wherein the toner has a glass transition temperature of from 40 to 60° C.

6. A developer, comprising the toner according to claim 2 and a carrier.

7. A process cartridge detachably attachable to an image forming apparatus, comprising:
a photoreceptor; and
a developing device,
the developing device containing the toner according to claim 2 or a developer comprising the toner according to claim 2.

8. An image forming apparatus, comprising:
an image bearing member configured to bear a toner image;
an intermediate transfer member in contact with the image bearing member;
a primary transfer unit configured to transfer the toner image from the image bearing member onto the intermediate transfer member; and
a secondary transfer unit in contact with the intermediate transfer member with pressure, configured to transfer the toner image from the intermediate transfer member onto a recording medium,
wherein the image bearing member has a smaller surface friction coefficient than the intermediate transfer member, and
wherein the toner image is formed using the toner according to claim 1.

9. The image forming apparatus according to claim 8, wherein the toner further comprises a paraffin wax having a melting point of from 60 to 90° C.,
wherein the toner has an endothermic peak in an amount of from 2.0 to 5.5 J/g in an endothermic curve measured by differential scanning calorimetry (DSC), and
wherein the toner has an average circularity of from 0.94 to 0.97.

10. The image forming apparatus according to claim 8, wherein the toner is manufactured by a method comprising:
dissolving or dispersing toner constituents comprising a polyester prepolymer having a functional group having a nitrogen atom, a polyester, the colorant, the paraffin wax, and an inorganic filler in an organic solvent, to prepare a toner constituent liquid; and
dispersing the toner constituent liquid in an aqueous medium while subjecting the polyester prepolymer to at least one of a cross-linking reaction or an elongation reaction to prepare the toner,
wherein the toner has a shape factor SF-1 of from 130 to 160 and a shape factor SF-2 of from 110 to 140.

11. The image forming apparatus according to claim 10, wherein the inorganic filler is a montmorillonite or a modified montmorillonite.

12. The image forming apparatus according to claim 8, wherein the toner has a glass transition temperature of from 40 to 60° C.

13. A toner, comprising:
a binder resin; and
a colorant,
wherein the toner produces (1) a torque of from 1.4 to 2.0 mNm and (2) a torque of from 1.7 to 2.0 mNm, when a cone rotor having a vertical angle of 60° and grooves on a surface thereof intrudes into a bulk of the toner at an intrusion speed of 5 mm/min for a depth of 20 mm while rotating at a rotation speed of 1 rpm, wherein the bulk of the toner is formed by consolidating 30 g of the toner in a cylindrical container having an internal diameter of 60 mm for 60 seconds with a consolidation load of (1) 585 g and (2) 1599 g, respectively.

14. The toner according to claim 13, further comprising a paraffin wax having a melting point of from 60 to 90° C.,
wherein the toner has an endothermic peak in an amount of from 2.0 to 5.5 J/g in an endothermic curve measured by differential scanning calorimetry (DSC), and
wherein the toner has an average circularity of from 0.94 to 0.97.

15. The toner according to claim 13, wherein the toner is manufactured by a method comprising:
dissolving or dispersing toner constituents comprising a polyester prepolymer having a functional group having a nitrogen atom, a polyester, the colorant, the paraffin wax, and an inorganic filler in an organic solvent, to prepare a toner constituent liquid; and
dispersing the toner constituent liquid in an aqueous medium while subjecting the polyester prepolymer to at least one of a cross-linking reaction or an elongation reaction to prepare the toner,
wherein the toner has a shape factor SF-1 of from 130 to 160 and a shape factor SF-2 of from 110 to 140.

16. The toner according to claim 15, wherein the inorganic filler is a montmorillonite or a modified montmorillonite.

17. The toner according to claim 13, wherein the toner has a glass transition temperature of from 40 to 60° C.

18. A developer, comprising the toner according to claim 13 and a carrier.

19. A process cartridge detachably attachable to an image forming apparatus, comprising:
a photoreceptor; and
a developing device,
the developing device containing the toner according to claim 13 or a developer comprising the toner according to claim 13.
